(19) United States
(12) Patent Application Publication
(10) Pub. No.: US 2022/0314968 A1
(43) Pub. Date: Oct. 6, 2022

(54) ELECTRONIC CONTROL DEVICE

(71) Applicant: Hitachi Astemo, Ltd., Hitachinaka-shi, Ibaraki (JP)

(72) Inventors: Yuki HORITA, Tokyo (JP); Hidehiro TOYODA, Hitachinaka-shi (JP)

(73) Assignee: Hitachi Astemo, Ltd., Hitachinaka-shi, Ibaraki (JP)

(21) Appl. No.: 17/633,639

(22) PCT Filed: Aug. 21, 2020
(86) PCT No.: PCT/JP2020/031732

§ 371 Date: Feb. 8, 2022

(30) Foreign Application Priority Data
Sep. 18, 2019 (JP) 2019-169821

(51) Int. Cl. B60W 30/08; G08G 1/16

(52) U.S. Cl. CPC B60W 30/08; G08G 1/16

(57) ABSTRACT

An electronic control device mounted on a vehicle includes a blind spot region specifying unit, an information obtaining unit, and a blind spot region dangerous event determining unit. The blind spot region specifying unit specifies a blind spot region that is not included in a detection range of a sensor mounted on the vehicle. The information obtaining unit obtains lane information of a road around the vehicle including the blind spot region. The blind spot region dangerous event determining unit judges assumed behavior of a latent obstacle that possibly exist in the blind spot region based on the lane information of the blind spot region and a positional relationship of the blind spot region on the road with respect to the vehicle.

### TECHNICAL FIELD

The present invention relates to an electronic control device.

### BACKGROUND ART

Recently, in order to realize comfortable and safe driving support and autonomous driving of a vehicle, a technique of judging a risk hidden in a region that becomes a blind spot of a sensor that recognizes a peripheral environment of the vehicle has been proposed. For example, Patent Literature 1 discloses a means of calculating a collision probability by setting a virtual mobile object that is assumed to exist in a blind spot region.

### CITATION LIST

### Patent Literature

Patent Literature 1: Japanese Unexamined Patent Application Publication No. 2012-104029

### SUMMARY OF INVENTION

### Technical Problem

With the invention described in Patent Literature 1, after a type of the virtual mobile object that is assumed to exist in a blind spot region is estimated, a speed of the virtual mobile object is estimated depending on the type of the virtual mobile object. However, behavior of a latent obstacle that possibly exists in a blind spot region differs according to an environment where the blind spot region is placed. Therefore, as in Patent Literature 1, with the means of calculating the collision probability by setting the speed based only on the type of the virtual mobile object, the behavior of the latent obstacle that possibly exists in the blind spot region cannot be appropriately judged, and thus, a risk is underestimated, which is likely to lead to dangerous driving support and autonomous driving.

### Solution to Problem

An electronic control device according to the present invention is mounted on a vehicle. The electronic control device includes a blind spot region specifying unit, an information obtaining unit, and a blind spot region dangerous event determining unit. The blind spot region specifying unit specifies a blind spot region that is not included in a detection range of a sensor mounted on the vehicle. The information obtaining unit obtains lane information of a road around the vehicle including the blind spot region. The blind spot region dangerous event determining unit judges assumed behavior of a latent obstacle that possibly exist in the blind spot region based on the lane information of the blind spot region and a positional relationship of the blind spot region on the road with respect to the vehicle.

### Advantageous Effects of Invention

With the present invention, behavior of a latent obstacle that possibly exists in a blind spot region can be appropriately judged.

### BRIEF DESCRIPTION OF DRAWINGS

FIG. 1 is a function block diagram illustrating a configuration of a vehicle system including a travel control device according to an embodiment of the present invention.

FIGS. 2A and 2B are explanatory views of a blind spot region data group.

FIG. 3 is a view illustrating a correlation of a function that the travel control device realizes.

FIG. 4 is a flowchart describing a process executed at a blind spot region dangerous event determining unit.

FIG. 5 is a view illustrating an example of a dangerous event model decision table.

FIG. 6 is a view illustrating a traveling scene corresponding to a first operation example of the vehicle system.

FIG. 7 is a view illustrating an example of a blind spot region dangerous event data group in the traveling scene of the first operation example.

FIG. 8 is a view illustrating an example of a potential obstacle data group in the traveling scene of the first operation example.

FIGS. 9A, 9B, 9C, and 9D are views illustrating a relationship of estimated arrival times between potential obstacles and an own vehicle at each position on lanes in the traveling scene of the first operation example.

FIG. 10 is a view illustrating an example of a potential risk map data group in the traveling scene of the first operation example.

FIG. 11 is a view illustrating a relationship between travel route candidates that the own vehicle can take and potential risks in the traveling scene of the first operation example.

FIGS. 12A and 12B are views illustrating an example of a calculation method of the travel route candidates and target speeds in the traveling scene of the first operation example.

FIG. 13 is a view illustrating a first traveling scene corresponding to a second operation example of the vehicle system.

FIG. 14 is a view illustrating an example of a potential obstacle data group and a potential risk map data group in the first traveling scene of the second operation example.

FIG. 15 is views illustrating a relationship of estimated arrival times between a potential obstacle and an own vehicle at each position on a lane in the first traveling scene of the second operation example.

FIG. 16 is a view illustrating a second traveling scene corresponding to the second operation example of the vehicle system.

FIG. 17 is views illustrating a relationship of estimated arrival times between a potential obstacle and an own vehicle at each position on a lane in the second traveling scene of the second operation example.

### DESCRIPTION OF EMBODIMENTS

The following describes the embodiment of the present invention using the drawings.

(System Configuration)

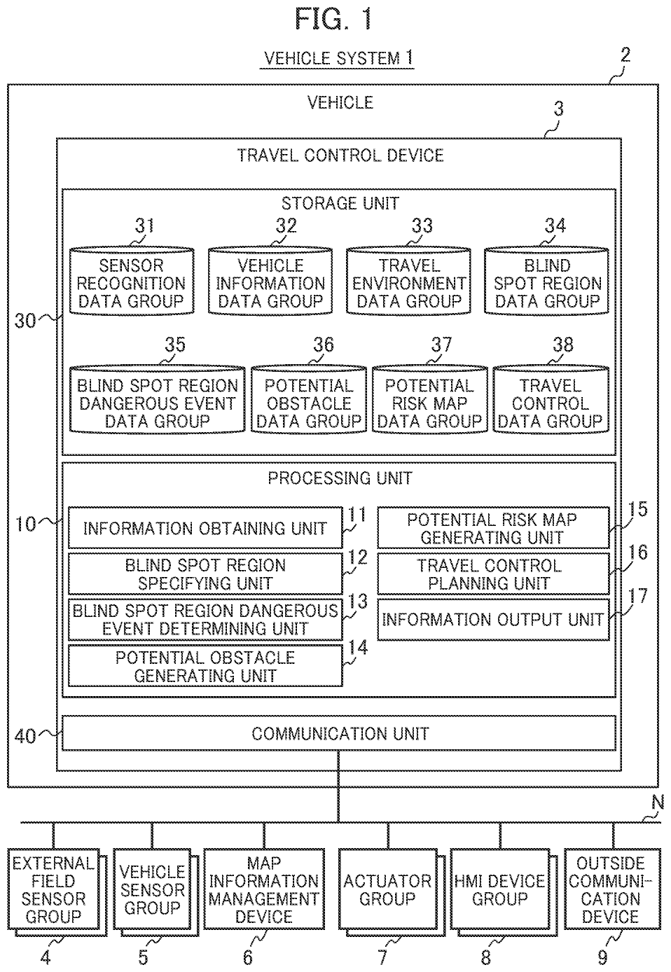

FIG. 1 is a function block diagram illustrating a configuration of a vehicle system 1 including a travel control device 3 according to an embodiment of the present invention. The vehicle system 1 is mounted on a vehicle 2. The vehicle system 1 performs appropriate driving support and travel control after recognizing a situation of travel roads at a periphery of the vehicle 2 and obstacles, such as peripheral vehicles. As illustrated in FIG. 1, the vehicle system 1 is configured including the travel control device 3, an external field sensor group 4, a vehicle sensor group 5, a map information management device 6, an actuator group 7, an HMI device group 8, and an outside communication device 9. The travel control device 3, the external field sensor group 4, the vehicle sensor group 5, the map information management device 6, the actuator group 7, the HMI device group 8, and the outside communication device 9 are connected to one another by a vehicle-mounted network N. Note that in the following, the vehicle 2 is occasionally referred to as an “own vehicle” 2 in order to discriminate the vehicle 2 from other vehicles.

The travel control device 3 is an ECU (Electronic Control Unit) mounted on the vehicle 2. The travel control device 3 generates travel control information for the driving support or the autonomous driving of the vehicle 2 based on various kinds of input information provided from the external field sensor group 4, the vehicle sensor group 5, the map information management device 6, the outside communication device 9, and the like, and outputs the travel control information to the actuator group 7 and the HMI device group 8. The travel control device 3 has a processing unit 10, a storage unit 30, and a communication unit 40.

The processing unit 10 is configured including, for example, a CPU (Central Processing Unit) that is a central arithmetic processing unit. However, in addition to the CPU, the processing unit 10 may be configured including a GPU (Graphics Processing Unit), an FPGA (Field-Programmable Gate Array), an ASIC (Application Specific Integrated Circuit), and the like or may be configured by any one of them.

The processing unit 10 has an information obtaining unit 11, a blind spot region specifying unit 12, a blind spot region dangerous event determining unit 13, a potential obstacle generating unit 14, a potential risk map generating unit 15, a travel control planning unit 16, and an information output unit 17 as its functions. The processing unit 10 realizes these by executing a predetermined operation program stored in the storage unit 30.

The information obtaining unit 11 obtains various kinds of information from the other devices connected to the travel control device 3 via the vehicle-mounted network N and store the various kinds of information in the storage unit 30. For example, information related to an obstacle around the vehicle 2 detected by the external field sensor group 4 and a detection region of the external field sensor group 4 is obtained and stored as a sensor recognition data group 31 in the storage unit 30. Further, information related to behavior, such as movement and a state, of the vehicle 2 detected by the vehicle sensor group 5 is obtained and stored as a vehicle information data group 32 in the storage unit 30. Further, information related to a travel environment of the vehicle 2 from the map information management device 6, the outside communication device 9, and the like is obtained and stored as a travel environment data group 33 in the storage unit 30.

The blind spot region specifying unit 12 specifies a blind spot region, at the periphery of the vehicle 2, which is not included in a detection range of the external field sensor group 4 based on the sensor recognition data group 31 obtained by the information obtaining unit 11 and stored in the storage unit 30. In the sensor recognition data group 31, the blind spot region itself may be expressed by, for example, a grid-like map representation, such as an OGM (Occupancy Grid Map), or information required to specify the blind spot region may be expressed by a set of the detection range (such as angle and distance) and detection information of the external field sensor group 4. The detection information of the external field sensor group 4 is, for example, point cloud data that an LiDAR (Light Detection And Ranging) or a RADAR (Radio Detection And Ranging) obtains. The information of each blind spot region that the blind spot region specifying unit 12 has specified is stored as a blind spot region data group 34 in the storage unit 30.

The blind spot region dangerous event determining unit 13 determines a representative dangerous event in the blind spot region that the blind spot region specifying unit 12 has specified based on the travel environment data group 33 obtained by the information obtaining unit 11 and stored in the storage unit 30. The representative dangerous event in the blind spot region is, for example, a combination considered to be the most dangerous for the vehicle 2 among combinations of a location and behavior that an obstacle can take, assuming that the obstacle exists in this blind spot region. The behavior of the obstacle includes travel parameters, such as an action, a running direction, and a speed of the obstacle that possibly exists in the blind spot region. A determination result of the dangerous event by the blind spot region dangerous event determining unit 13 is stored as a blind spot region dangerous event data group 35 in the storage unit 30.

Based on the determination result of the dangerous event in each blind spot region by the blind spot region dangerous event determining unit 13, the potential obstacle generating unit 14 generates a virtual obstacle that takes behavior corresponding to this dangerous event as a latent obstacle that possibly exists in this blind spot region. This latent obstacle is referred to as a “potential obstacle” below. Information of the potential obstacle that the potential obstacle generating unit 14 has generated is stored as a potential obstacle data group 36 in the storage unit 30.

The potential risk map generating unit 15 generates a potential risk map that expresses a latent travel risk for each location at the periphery of the vehicle 2 based on assumed behavior of the potential obstacle that the potential obstacle generating unit 14 has generated and the behavior of the vehicle 2 that the vehicle information data group 32 obtained by the information obtaining unit 11 and stored in the storage unit 30 indicates. Information of the potential risk map that the potential risk map generating unit 15 has generated is stored as a potential risk map data group 37 in the storage unit 30.

The travel control planning unit 16 plans a track that the vehicle 2 should travel based on the potential risk map that the potential risk map generating unit 15 has generated and the like and decides a control command value of the actuator group 7 for controlling the vehicle 2 so as to follow the planned track. Information of the planned track and the control command value of the actuator group 7 that the travel control planning unit 16 has decided is stored as a travel control data group 38 in the storage unit 30.

The information output unit 17 outputs various kinds of information to the other devices connected to the travel control device 3 via the vehicle-mounted network N. For example, the control command value included in the travel control data group 38 is output to the actuator group 7 to control the travel of the vehicle 2. Further, for example, the planned track and the like included in the sensor recognition data group 31, the potential risk map data group 37, and the travel control data group 38 is output to the HMI device group 8 and presented to an occupant of the vehicle 2. This allows for presenting how the vehicle system 1 interprets the peripheral travel environment (display of the sensor recognition data group 31 and the potential risk map data group 37) and what sort of traveling the vehicle system 1 plans (display of the planned track of the travel control data group 38) to the occupant, in the vehicle 2 during the autonomous driving.

The storage unit 30 is configured, for example, including a storage device, such as an HDD (Hard Disk Drive), a flash memory, and a ROM (Read Only Memory), and a memory, such as an RAM. In the storage unit 30, a program that the processing unit 10 processes and a data group and the like required for the process are stored. Further, as a main memory when the processing unit 10 executes the program, the storage unit 30 is also used for a use application of temporarily storing data required for an operation of the program. In this embodiment, as the information for realizing the function of the travel control device 3, the sensor recognition data group 31, the vehicle information data group 32, the travel environment data group 33, the blind spot region data group 34, the blind spot region dangerous event data group 35, the potential obstacle data group 36, the potential risk map data group 37, the travel control data group 38, and the like are stored in the storage unit 30.

The sensor recognition data group 31 is a set of data related to the detection information or a detection state by the external field sensor group 4. The detection information is, for example, information related to environmental elements, such as obstacle, road markings, signs, and signals around the vehicle 2 that the external field sensor group 4 has specified based on its sensing information, and the sensing information itself (such as point cloud information of the LiDAR and the RADAR, a camera image, and a parallax image of a stereo camera) around the vehicle 2 by the external field sensor group 4. The detection state is information showing the region that this sensor has detected and its accuracy, and includes, for example, a grid-like map, such as the OGM.

The vehicle information data group 32 is a set of data related to the behavior of the vehicle 2 detected by the vehicle sensor group 5 and the like. The data related to the behavior of the vehicle 2 is information indicating the movement, the state, and the like of the vehicle 2, and include, for example, the information, such as a position of the vehicle 2, a travel speed, a steering angle, a manipulated variable of an accelerator, a manipulated variable of a brake, and a travel route.

The travel environment data group 33 is a set of data related to the travel environment of the vehicle 2. The data related to the travel environment is information related to roads around the vehicle 2 including the road on which the vehicle 2 is traveling. This includes, for example, information related to shapes and attributes (such as running direction, speed limit, and travel restriction) of lanes constituting the roads around the vehicle 2, signal information, traffic information related to a traffic condition (such as average speed) of each road and lane, statistical knowledge information based on past case examples, and the like. The static information, such as the shapes and the attributes of the roads and lanes, is included in, for example, map information obtained from the map information management device 6 and the like. On the other hand, the quasi-dynamic or dynamic information, such as the signal information, the traffic information, and the statistical knowledge information, is obtained via the outside communication device 9. The statistical knowledge information includes, for example, information and the like related to geographical locations and time slots where and when there are many accident cases, and types of the cases.

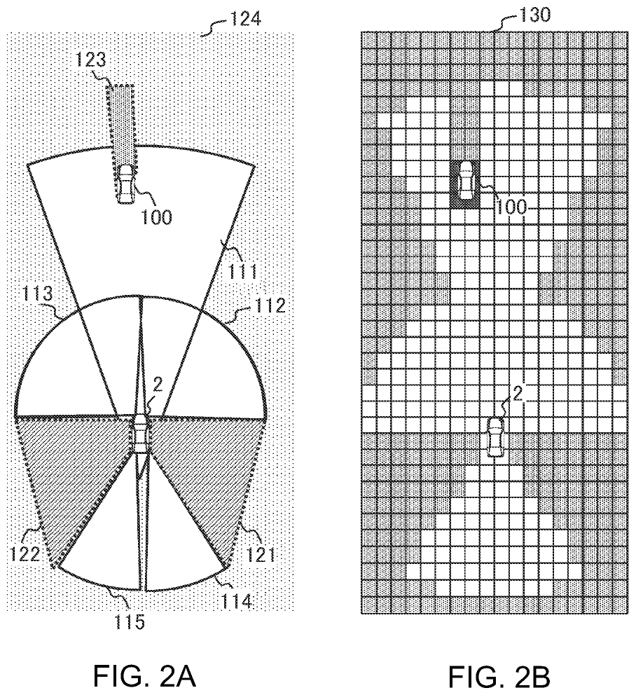

The blind spot region data group 34 is a set of data related to a region that is not included in the detection range of the external field sensor group 4 of the vehicle 2, that is, the blind spot region that means a region in which the external field sensor group 4 cannot detect the sensing information. An example of expressing the data related to the blind spot region will be described later with FIG. 2. The blind spot region data group 34 is generated and stored by the blind spot region specifying unit 12 based on the information of the sensor recognition data group 31 obtained by the information obtaining unit 11.

The blind spot region dangerous event data group 35 is a set of data related to the representative dangerous event in each blind spot region that the blind spot region dangerous event determining unit 13 has determined. The data related to the dangerous event in the blind spot region is information related to a risk in which an obstacle that the external field sensor group 4 cannot recognize comes into contact with the vehicle 2 in a case where the obstacle exists in the blind spot region. This includes, for example, a type (such as vehicle, pedestrian, and bicycle) and position of the obstacle that is judged to be possible to exist in this blind spot region, an action that this obstacle can take (for example, in the case of a vehicle, lane following, lane change, stop, and the like), parameters of this action (such as running direction, speed, and acceleration), and the like. The blind spot region dangerous event data group 35 is generated and stored by the blind spot region dangerous event determining unit 13 based on the information of the blind spot region data group 34 generated by the blind spot region specifying unit 12 and the information of the travel environment data group 33 obtained by the information obtaining unit 11.

The potential obstacle data group 36 is a set of data related to a virtual obstacle (potential obstacle) that cannot be recognized by the external field sensor group 4 (for example, that exists in the blind spot region of the external field sensor group and is not detected) but is considered to be possible to potentially exist. This includes, for example, the type and position of the obstacle, the speed, the acceleration, a predicted track estimated from the action that can be assumed, and the like. The potential obstacle data group 36 is generated and stored by the potential obstacle generating unit 14 based on the information of the blind spot region dangerous event data group 35 generated by the blind spot region dangerous event determining unit 13.

The potential risk map data group 37 is data related to the potential risk map indicating the risk for each location in which the vehicle 2 collides with the potential obstacle hidden in the blind spot region at the periphery of the vehicle 2. The potential risk map is generated by the potential risk map generating unit 15 and is expressed by, for example, a grid-like map as described later.

The travel control data group 38 is a data group related to planning information for controlling the travel of the vehicle 2 and includes the planned track of the vehicle 2 and the control command value that is output to the actuator group 7, and the like. These pieces of information in the travel control data group 38 are generated and stored by the travel control planning unit 16.

The communication unit 40 has a communication function with the other devices connected via the vehicle-mounted network N. When the information obtaining unit 11 obtains the various kinds of information from the other devices via the vehicle-mounted network N, and when the information output unit 17 outputs the various kinds of information to the other devices via the vehicle-mounted network N, this communication function of the communication unit 40 is used. The communication unit 40 is configured including, for example, a network card and the like compliant to communication standards of IEEE802.3, a CAN (Controller Area Network), and the like. The communication unit 40 sends and receives the data between the travel control device 3 and the other devices in the vehicle system 1 based on various kinds of protocols.

Note that, in this embodiment, although the communication unit 40 and the processing unit 10 are described separately, a part of the process of the communication unit 40 may be executed in the processing unit 10. For example, the configuration may be such that an equivalent of a hardware device in a communication process is positioned in the communication unit 40 and a device driver group, a communication protocol process, and the like other than that are positioned in the processing unit 10.

The external field sensor group 4 is a collective body of devices that detect the state around the vehicle 2. The external field sensor group 4 corresponds to, for example, a camera device, a millimeter-wave radar, an LiDAR, a sonar, and the like. The external field sensor group 4 detects the environmental elements, such as the obstacle, the road markings, the signs, and the signals in a predetermined range from the vehicle 2 and outputs these detection results to the travel control device 3 via the vehicle-mounted network N. The “obstacle” is, for example, another vehicle that is a vehicle other than the vehicle 2, a pedestrian, a falling object on a road, a roadside, and the like. The “road marking” is, for example, a white line, a crosswalk, a stop line, and the like. Further, the external field sensor group 4 also outputs information related to the detection state to the travel control device 3 via the vehicle-mounted network N based on its own sensing range and its state.

The vehicle sensor group 5 is a collective body of devices that detect various states of the vehicle 2. Each vehicle sensor detects, for example, the position information, the travel speed, the steering angle, the manipulated variable of the accelerator, the manipulated variable of the brake, and the like of the vehicle 2 and outputs them to the travel control device 3 via the vehicle-mounted network N.

The map information management device 6 is a device that manages and provides digital map information around the vehicle 2. The map information management device 6 is composed of, for example, a navigation device and the like. The map information management device 6 includes, for example, digital road map data of a predetermined region including the periphery of the vehicle 2 and is configured to specify a current position of the vehicle 2 on the map, that is, the road and lane on which the vehicle 2 is traveling based on the position information and the like of the vehicle 2 output from the vehicle sensor group 5. Further, the specified current position of the vehicle 2 and the map data of its periphery are output to the travel control device 3 via the vehicle-mounted network N.

The actuator group 7 is a device group that controls control elements, such as steering, a brake, and an accelerator, which decide the movement of the vehicle 2. The actuator group 7 controls the behavior of the vehicle 2 by controlling the movement of the control elements, such as the steering, the brake, and the accelerator, based on operation information of a steering wheel, a brake pedal, and an accelerator pedal by a driver and the control command value output from the travel control device 3.

The HMI device group 8 is a device group for performing information input from the driver and the occupant to the vehicle system 1 and information notification from the vehicle system 1 to the driver and the occupant. The HMI device group 8 includes a display, a speaker, a vibrator, a switch, and the like.

The outside communication device 9 is a communication module that performs wireless communication with an outside of the vehicle system 1. The outside communication device 9 is, for example, configured to be able to communicate with a center system (not illustrated) that provides and delivers a service to the vehicle system 1 and the internet.

FIG. 2 is explanatory views of the blind spot region data group 34. FIG. 2A is a view illustrating an example of a condition in which the vehicle 2 is placed, and FIG. 2B is a view illustrating an example of a blind spot region map corresponding to FIG. 2A.

In the example illustrated in FIG. 2A, the external field sensor group 4 of the vehicle 2 is composed of five sensors. These respective sensors can each detect an obstacle that exist in detection ranges of reference signs 111 to 115 at a maximum. However, when an obstacle exists, the range farther from the obstacle is blocked by this obstacle, and accordingly, whether or not further obstacles exist cannot be detected even in the detection range. In FIG. 2A, a white region shows a range in which the external field sensor group 4 detects that an obstacle does not exist, and a hatched region shows a range in which the external field sensor group 4 cannot detect an obstacle, that is, a range that becomes a blind spot of the external field sensor group 4.

As illustrated in FIG. 2A, the blind spot regions of the external field sensor group 4 are the regions in which the regions shown by reference signs 121, 122, and 124 that are outside of the detection ranges of the external field sensor group 4 and a region 123 that is blocked by another vehicle 100 as an obstacle are combined. Note that the blind spot regions that are outside of the detection ranges of the external field sensor group 4 are roughly divided into two blind spot regions. One is a blind spot region that occurs because a distance from the external field sensor group 4 is far, such as the region 124, and the other is a blind spot region that occurs in a direction that the external field sensor group 4 cannot originally detect, such as the region 121 and the region 122. Of these, the blind spot region that occurs due to the distance does not often become constant because the detection range of the external field sensor group 4 varies in response to the travel environment, such as weather conditions. Therefore, it is preferable that the detection range of the external field sensor group 4 is dynamically calculated in response to the travel environment of the vehicle 2 and the blind spot region is set in response to the calculation result.

In a situation illustrated in FIG. 2A, the blind spot region specifying unit 12 creates, for example, a blind spot region map 130 illustrated in FIG. 2B by specifying positions and shapes of the blind spot regions 121 to 124 with respect to the vehicle 2 and stores the blind spot region data group 34 indicating this in the storage unit 30. In the blind spot region map 130 of FIG. 2B, for a predetermined region specified by an x-y coordinate system with the current position of the vehicle 2 as a reference point, a detection state of the external field sensor group 4 at each position that is indicated by coordinate values (x, y) in which the x and the y are each a variable is expressed as a grid-like map. This blind spot region map 130 corresponds to a grid map (OGM) of the blind spot regions 121 to 124 in FIG. 2A.

With the blind spot region data group 34, the detection state of the external field sensor group 4 at each position is expressed by, for example, ternary values of “with obstacle (detected)”, “without obstacle (detected)”, and “unknown (not detected)”. In the blind spot region map 130 illustrated in FIG. 2B, a black region set at the periphery of the vehicle 100 indicates the “with obstacle (detected)”, and hatched regions corresponding to the blind spot regions 121 to 124 in FIG. 2A indicate the “unknown (not detected)”. Further, white regions other than those, that is, the regions in which the periphery of the vehicle 100 and the blind spot region 123 are removed from the detection ranges 111 to 115 in FIG. 2A indicate the “without obstacle (detected)”.

Note that, although an example of the blind spot region map 130 in which the detection state of the external field sensor group 4 is indicated by the ternary values is illustrated in FIG. 2B, a blind spot region map may be expressed by indicating a probability that an obstacle exists by continuous values (decimal numbers from 0 to 1) instead of a discrete value that is the detection state of a sensor. Further, with the blind spot region data group 34, the positions and shapes of the blind spot regions may be expressed in a unit of cell of the grid-like map as illustrated in FIG. 2B or may be expressed by a collective body of a plurality of cells. Furthermore, with the blind spot region data group 34, the positions and shapes of the blind spot regions may be expressed by other than the grid-like map. For example, the positions and shapes of the blind spot regions 122 to 124 in FIG. 2A may be expressed by positions, shapes, and the like of sides and apexes of a figure corresponding to each blind spot region. In the following description on this embodiment, in order to simplify the description, each blind spot region of the blind spot region data group 34 is expressed not in the unit of cell of the grid-like map, but by the positions and shapes on the blind spot region map.

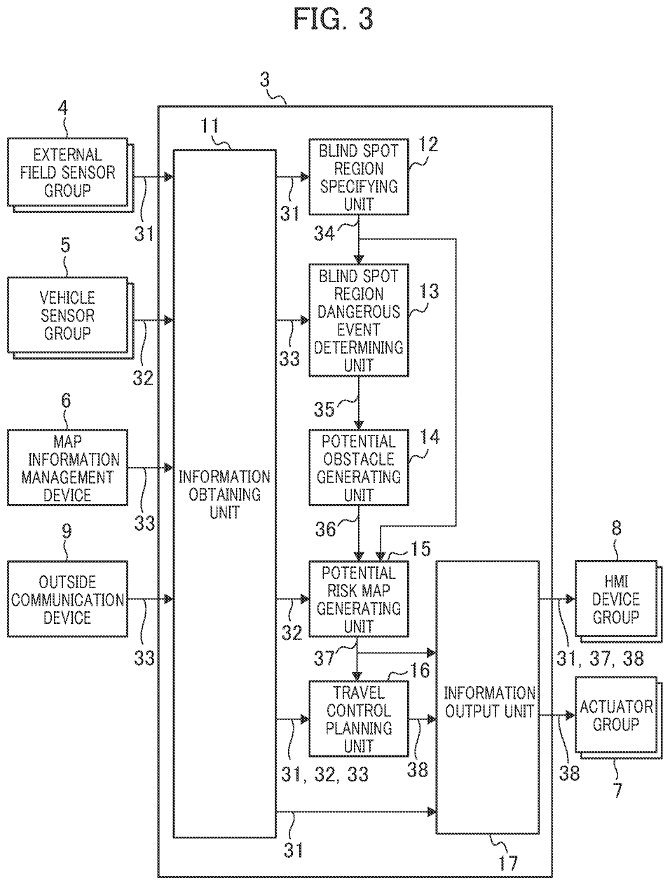

Next, operations of the vehicle system 1 of this embodiment will be described using FIG. 3 to FIG. 17.

The travel control device 3 judges a risk of a potential obstacle in each blind spot region that exists around the vehicle 2 based on the information obtained from the external field sensor group 4 and the like and generates a potential risk map that maps the judgement result. Then, a planned track of the vehicle 2 is set using the generated potential risk map, and a control command value for performing a travel control of the vehicle 2 is generated and output to the actuator group 7. The actuator group 7 controls each actuator of the vehicle 2 in accordance with the control command value that the travel control device 3 outputs. This realizes the travel control of the vehicle 2. Further, for the travel control of the vehicle 2, the travel control device 3 generates HMI information as information to be notified to a driver and an occupant, and outputs the HMI information to the HMI device group 8. This allows for causing the driver to recognize the risk in traveling and urging the driver for safe driving and allows for presenting the state of the vehicle system 1 during automatic traveling to the driver and the occupant.

FIG. 3 is a view illustrating a correlation of a function that the travel control device realizes. The travel control device is configured to execute processes of, for example, the information obtaining unit 11, the blind spot region specifying unit 12, the blind spot region dangerous event determining unit 13, the potential obstacle generating unit 14, the potential risk map generating unit 15, the travel control planning unit 16, and the information output unit 17 illustrated in FIG. 1 in an order illustrated in FIG. 3. A sequence of the processes is executed periodically, for example, every 100 ms.

The information obtaining unit 11 obtains necessary information from the other devices via the vehicle-mounted network N and store the necessary information in the storage unit 30. Specifically, the information of the sensor recognition data group 31 from the external field sensor group 4, the information of the vehicle information data group 32 from the vehicle sensor group 5, and the information of the travel environment data group 33 from the map information management device 6 and the outside communication device 9 are each obtained, stored in the storage unit 30, and handed over to a processing unit in a latter part.

The blind spot region specifying unit 12 performs a process of generating the blind spot region data group 34 based on the sensor recognition data group 31 that the information obtaining unit 11 has obtained, stores the blind spot region data group 34 in the storage unit 30, and hands over the blind spot region data group 34 to the blind spot region dangerous event determining unit 13 and the potential risk map generating unit 15. At this time, when information equivalent to the blind spot region data group 34 (for example, OGM) is included in the sensor recognition data group 31, the blind spot region data group 34 can be generated by applying necessary corrections (such as coordinates transformation and time correction) to the information. On the other hand, when information of the state that the external field sensor group 4 detects at each predetermined process cycle, for example, the detection range (such as an angle and a distance), and detection information only are included in the sensor recognition data group 31, it is preferable that the detection state being stochastically most probable is estimated by combining with the blind spot region data group 34 generated at the previous process cycle and the blind spot region data group 34 for this time is generated by judging a blind spot region from the estimation result.

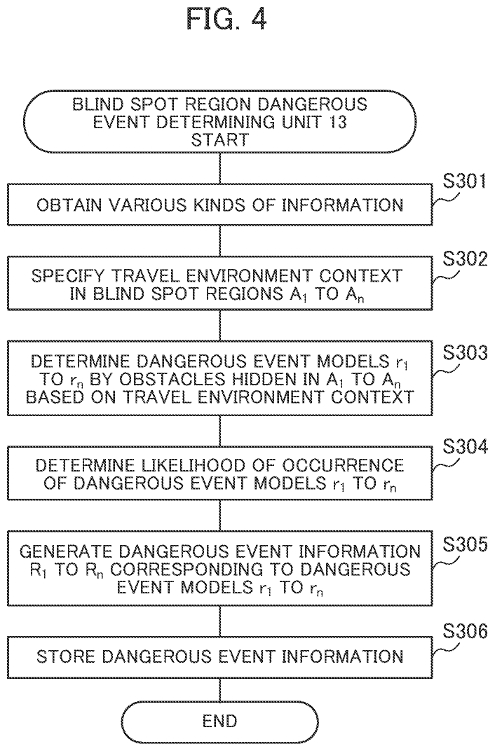

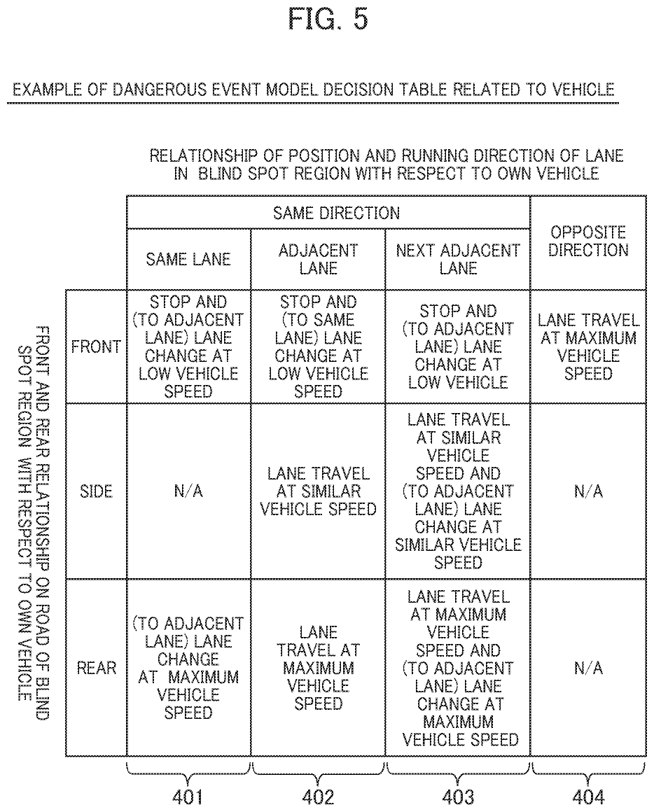

The blind spot region dangerous event determining unit 13 performs a process of determining a dangerous event in the blind spot region based on the blind spot region data group 34 that the blind spot region specifying unit 12 has generated and the travel environment data group 33 that the information obtaining unit 11 has obtained. The detail of this process will be described later using FIG. 4 and FIG. 5. Then, the blind spot region dangerous event data group 35 is generated from the process result, stored in the storage unit 30, and handed over to the potential obstacle generating unit 14.

The potential obstacle generating unit 14 performs a process of setting a potential obstacle that is a virtual potential obstacle corresponding to this dangerous event with respect to each blind spot region based on the blind spot region dangerous event data group 35 that the blind spot region dangerous event determining unit 13 has generated and generating the potential obstacle data group 36 that is the information of this potential obstacle. Then, the generated potential obstacle data group 36 is stored in the storage unit 30 and handed over to the potential risk map generating unit 15.

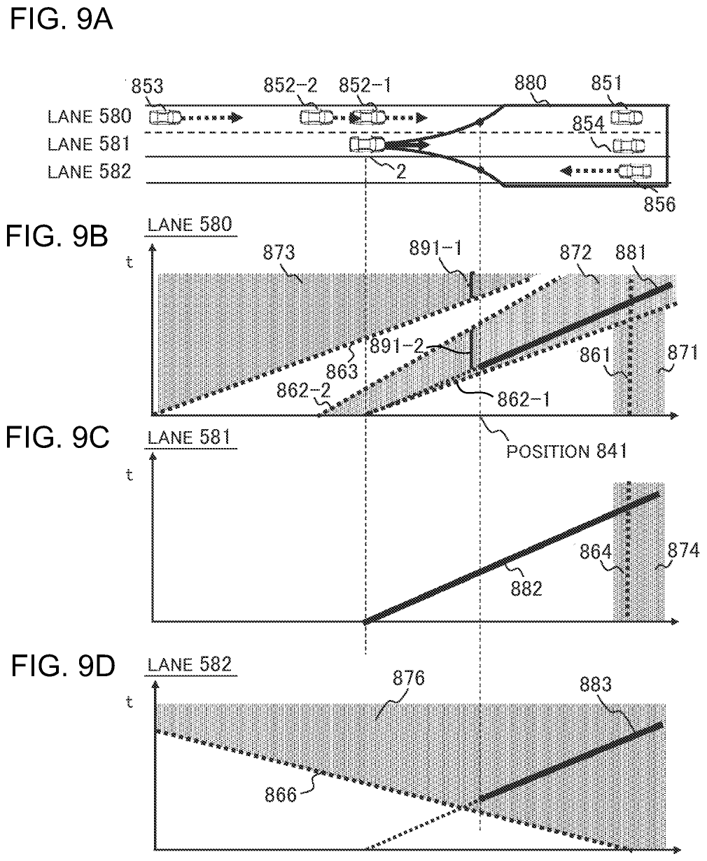

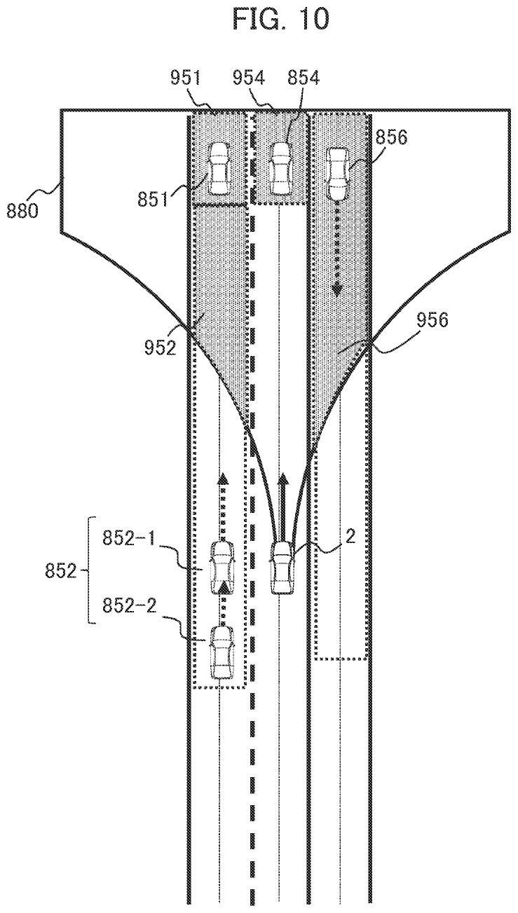

The potential risk map generating unit 15 calculate a potential risk brought by the potential obstacle in each blind spot region based on the blind spot region data group 34 that the blind spot region specifying unit 12 has generated, the potential obstacle data group 36 that the potential obstacle generating unit 14 has generated, and the vehicle information data group 32 that the information obtaining unit 11 has obtained. Then, a process of setting a potential risk map in response to the potential risk to the periphery of the vehicle 2 and generating the potential risk map data group 37 that is the information of this potential risk map is performed. The detail of this process will be described later using FIG. 9 and FIG. 10. The potential risk map generating unit 15 stores the generated potential risk map data group 37 in the storage unit 30 and hands over the potential risk map data group 37 to the travel control planning unit 16 and the information output unit 17.

The travel control planning unit 16 plans a track of a travel control of the vehicle 2 based on the potential risk map data group 37 that the potential risk map generating unit 15 has generated and the sensor recognition data group 31, the vehicle information data group 32, and the travel environment data group 33 that the information obtaining unit 11 has obtained, and the like and generates a control command value and the like for following the track. Then, a process of generating the travel control data group from the generated planned track of the vehicle 2 and the control command value is performed. The travel control planning unit 16 stores the generated travel control data group 38 in the storage unit 30 and hands over the travel control data group 38 to the information output unit 17.

The information output unit 17 outputs the control command value to the actuator group 7 based on the travel control data group 38 that the travel control planning unit 16 has generated. Further, based on the sensor recognition data group 31 that the information obtaining unit 11 has obtained, the potential risk map data group 37 that the potential risk map generating unit 15 has generated, the travel control data group 38 that the travel control planning unit 16 has generated, and the like, information for presenting a travel environment around the vehicle 2 and the planned track to an occupant is output to the HMI device group 8.

(Blind Spot Region Dangerous Event Determining Process)

FIG. 4 is a flowchart describing a process executed at the blind spot region dangerous event determining unit 13 in FIG. 1 and FIG. 3. First, in a step S301, the blind spot region dangerous event determining unit 13 obtains the blind spot region data group 34 that the blind spot region specifying unit 12 has specified and the travel environment data group 33 that the information obtaining unit 11 has obtained from the storage unit 30. The following describes the flowchart of the FIG. 4 assuming that n pieces of blind spot regions A₁ to Aₙ have been specified by the blind spot region specifying unit 12 and these blind spot regions A₁ to Aₙ have been indicated by the blind spot region data group 34.

Subsequently, in a step S302, the blind spot region dangerous event determining unit 13 specifies a travel environment context in the respective blind spot regions A₁ to Aₙ by cross-checking the travel environment data group 33 and the blind spot region data group 34 obtained in the step S301. The travel environment context is information related to a travel environment in a blind spot region. For example, the shape and attributes (such as a running direction, a speed limit, travel restrictions, and propriety of a lane change) of a lane and a crosswalk region in a blind spot region, signal information and a traffic condition (such as an average speed) related to the lane and the crosswalk region, the state of an obstacle around this blind spot region, statistical knowledge information related to this blind spot region, and the like are included.

Subsequently, in a step S303, the blind spot region dangerous event determining unit 13 determines dangerous event models r₁ to rₙ with respect to respective range elements in the respective blind spot regions A₁ to Aₙ based on the travel environment context specified at the step S302. Then, in a subsequent step S304, the blind spot region dangerous event determining unit 13 determines a likelihood of occurrence of the respective dangerous event models r₁ to rₙ determined in the step S303 based on the travel environment context. The dangerous event model is a model that shows a type and an action pattern of an obstacle that is considered to be dangerous when the obstacle exists in a blind spot region concerned. That is, it means that the processes of the steps S303 and S304 judge what sort of obstacle may be hidden in this blind spot region and what sort of action the obstacle may take based on an estimation result of the travel environment where the blind spot region is placed. Note that, although the dangerous event models r₁ to rₙ are to be determined with respect to the blind spot regions A₁ to Aₙ on a one-to-one basis in the above, a plurality of dangerous event models may be determined with respect to one blind spot region.

Specific examples of the processes of the steps S303 and S304 will be described below. For example, in the case where a blind spot region is a crosswalk region, a dangerous event model in which a bicycle crosses the crosswalk in this blind spot region is assumed. Although a pedestrian may be assumed as the dangerous event model, it is preferable that the bicycle having the most severe rushing out speed from the blind spot region is assumed because assuming the most dangerous event allows for responding to other dangerous events. The likelihood of occurrence of this dangerous event model is judged in response to, for example, the state of a signal for pedestrians related to the same crosswalk. In the case immediately after the signal for pedestrians turns green or red, a likelihood that pedestrians and bicycles cross is high, whereas in the case where the signal for pedestrians has been red for a certain period of time, the likelihood is low. Such a judgment is effective especially in the case where the vehicle 2 turns right or left at an intersection.

Further, for example, in the case where a blind spot region is in contact with a sidewalk region, a dangerous event model in which a pedestrian rushes out to a roadway is assumed. The likelihood of occurrence of the dangerous event model is judged by, for example, whether a parked vehicle (specifically, a vehicle, such as a bus or a taxi) exists around this blind spot region. In the case where the parked vehicle exists, it can be judged that a likelihood in which a person who has got out of the same vehicle and a person who is going to get in the same vehicle forcedly crosses the road becomes high. Further, a school zone and knowledge information in which statistically accidents occur frequently can also become materials to judge the likelihood of occurrence of this dangerous event model is high.

In the case where a potential obstacle is a vehicle, compared with the case of a pedestrian and a bicycle, a variation width of behavior in response to a travel environment is large. Therefore, when the behavior is commonly treated, an influence received is particularly large in the case of a vehicle and a risk of leading to an erroneous judgment is high. The detail of a process of specifying a dangerous event model related to a vehicle will be described later with FIG. 5.

Next, in a step S305, the blind spot region dangerous event determining unit 13 generates dangerous event information R₁ to Rn corresponding respectively to the dangerous event models r₁ to rₙ determined in the step S303. In the determination of the dangerous event models r₁ to rₙ of the step S303, only the type and the action pattern of a potential obstacle in the respective blind spot regions A₁ to Aₙ are specified. However, in the step S305, based on a dynamic aspect (such as a traffic condition) of the travel environment, specific parameters of this potential obstacle are decided and reflected on the dangerous event information R₁ to Rₙ.

Note that, since evenly evaluating the risks of the dangerous event models of all the blind spot regions may cause the risks to be considered excessively, in the process of the step S305, it is preferable that the dangerous event information is selectively generated in consideration of the likelihood of occurrence of each dangerous event model determined in the step S304. For example, only the dangerous event model determined to have a high likelihood of occurrence in the step S304 is set as a target for generating the dangerous event information in the step S305. In that case, in the example of the above-described dangerous event model based on the crosswalk region, in the case immediately after the signal for pedestrians turns green or red, corresponding dangerous event information is generated. Alternately, the likelihood of occurrence for each dangerous event model may be considered by adding the information related to a likelihood of occurrence determined in the step S304 to the dangerous event information and setting so that, at the time of judging a risk of a potential obstacle in a latter part, the risk is increased as the likelihood of occurrence increases.

Finally, in a step S306, the blind spot region dangerous event determining unit 13 stores the dangerous event information R₁ to Rₙ generated in the step S305 to the blind spot region dangerous event data group 35 in the storage unit 30. Afterwards, the process of the blind spot region dangerous event determining unit 13 ends.

FIG. 5 is an example of a dangerous event model decision table for specifying a dangerous event model related to a vehicle in the step S303 of FIG. 4. In the table of FIG. 5, the relationship of a position and a running direction of a lane in a blind spot region with respect to the own vehicle 2 is classified in the lateral direction, and positional relationship (front and rear relationship on a road) on a road of a blind spot region with respect to the own vehicle 2 is classified in the longitudinal direction. For each combination of these classifications, a dangerous event model of each potential obstacle in the case where the potential obstacle in each blind spot region at the periphery of the own vehicle 2 is a vehicle is set in the dangerous event model decision table of FIG. 5.

In the case of a potential obstacle that exists in a blind spot region on a lane in an opposite direction to the own vehicle 2, the most dangerous is an oncoming vehicle that moves toward the own vehicle from a blind spot at a high speed. However, in the case of a blind spot region on a side or a rear of the own vehicle 2, even if an oncoming vehicle exists, the oncoming vehicle passes without colliding with the own vehicle, and thus, there is no risk to the own vehicle 2. Therefore, as illustrated in a row 404 of FIG. 5, for the lane in the opposite direction, only in the case where the front and rear relationship on a road is a “FRONT”, that is, in the case of a blind spot region positioned at a front of the own vehicle 2 on the road, a “LANE TRAVEL AT MAXIMUM VEHICLE SPEED” is decided as the dangerous event model. On the other hand, in the case where the front and rear relationship on a road is a “SIDE” and a “REAR”, the dangerous event models are a “N/A”. This indicates that a dangerous event model is not set in a blind spot region positioned at the side or the rear of the own vehicle 2 on the road. Note that the “LANE TRAVEL AT MAXIMUM VEHICLE SPEED” means a model of the vehicle traveling at the highest speed that can be assumed in that lane. The highest speed that can be assumed in each lane can be judged, for example, in consideration of a legally permitted speed of the road to which this lane belongs and a traffic condition (traffic jam situation) of this lane based on the traffic information included in the travel environment data group 33.

In FIG. 5, the “FRONT”, “SIDE”, and “REAR” indicate the positional relationship between the own vehicle 2 and a blind spot region along a road and does not necessarily indicate the positional relationship in space. For example, when a road is curved, a blind spot region that lies ahead in traveling on that road is positioned on a side of the own vehicle 2 in space in some cases. However, even in such a case, the positional relationship of this blind spot region is treated as the “FRONT” in FIG. 5. Further, as the same applies to a blind spot region of a road to be connected at an intersection ahead, regardless of the positional relationship with the own vehicle 2 in space, the positional relationship of the blind spot region is treated as the “FRONT”. Further, in this case, for a running direction of a lane in the blind spot region with respect to the own vehicle 2, a lane in the running direction away from this intersection is treated as in a “SAME DIRECTION”, and a lane in the running direction toward this intersection is treated as in an “OPPOSITE DIRECTION”.

In the case of a potential obstacle in a blind spot region on a lane in the same direction as the own vehicle 2, depending on the positional relationship on the road with respect to the own vehicle 2, the most dangerous travel speed changes. Specifically, when the front and rear relationship on a road is the “FRONT”, assuming that a likelihood of traveling in reverse is not considered, a case where the travel speed of the potential obstacle is zero, that is, a stopping vehicle becomes the most dangerous event. On the other hand, when the front and rear relationship on a road is the “REAR”, a case where the travel speed of the potential obstacle is high, that is, a vehicle moving toward the own vehicle 2 at a high speed becomes the most dangerous event. Further, when the front and rear relationship on a road is the “SIDE”, a case where the travel speed of the potential obstacle is similar, that is, a vehicle remaining on a side of the own vehicle 2 for a long time becomes the most dangerous event.

Note that, when the front and rear relationship on a road is the “SIDE”, not only the vehicle remaining on a side of the own vehicle 2 for a long time, but also a vehicle passing by a side at a higher speed than the own vehicle 2 is considered to be dangerous. However, as for the vehicle thus having a speed difference from the own vehicle 2, as long as a region detectable by the external field sensor group 4 exists on rear lateral sides of the own vehicle 2 as in FIG. 2, this vehicle can be often treated as overt obstacle information by tracking from information at the time of detecting in that region. Accordingly, the vehicle does not need to be considered as a latent dangerous event. On the other hand, in the case of the vehicle having no speed difference from the own vehicle 2 as described above, the vehicle is hidden in a blind spot region for a long time, and thereby tracking of information at the time of detecting is interrupted. Therefore, the vehicle needs to be considered as a latent dangerous event in the blind spot region. Further, when a region detectable by the external field sensor group 4 does not exist on the rear lateral sides of the own vehicle 2, that is, when all the rear lateral sides are blind spot regions, these blind spot regions are also treated as at the “REAR”. Therefore, a risk of the vehicle passing by the side at a higher speed than the own vehicle 2 can be also considered.

Further, when a plurality of lanes in the same direction as the own vehicle 2 exist, a vehicle may change lanes. Therefore, as a dangerous event model, in addition to a model of a vehicle that follows on a same lane, a model of a vehicle that changes lanes needs to be considered. However, a region where the lane change is allowed is specified by line types of a lane boundary line and signs. Therefore, for a region that can be judged by the travel environment data group 33 that the lane change is not allowed, it is preferable to judge that the likelihood of occurrence of a dangerous event model in which a vehicle changes lanes in this region is low in the step S304 of FIG. 4, and to suppress generating a dangerous event information or to evaluate its risk to be low in the subsequent step S305.

In the dangerous event model decision table of FIG. 5, based on a way of thinking as described above, dangerous event models of another vehicle that exists as a potential obstacle in blind spot regions on lanes in the same direction as the own vehicle 2 are set as in rows 401 to 403. Note that, since the dangerous event model decision table of FIG. 5 is for judging a risk of the other vehicle with respect to the own vehicle 2, a lane change in the directions toward the same lane as the own vehicle 2 or an adjacent lane is considered, and a lane change in other directions is not excluded.

For example, when the front and rear relationship on a road is the “FRONT”, a stopping vehicle is the most dangerous event as described above. However, when another vehicle changes lanes, the other vehicle needs a certain amount of speed. Therefore, in the table of FIG. 5, a “LANE CHANGE AT LOW VEHICLE SPEED” as a dangerous event model corresponding to a lane change as well as a “STOP” as a dangerous event model corresponding to following on the same lane are set.

Note that, in the table of FIG. 5, dangerous event models that cannot occur in the relationship with an existence of the own vehicle 2 are excluded. Specifically, when the position of a lane is on the “SAME LANE” and the front and rear relationship on a road is the “SIDE”, existence regions of the own vehicle 2 and the other vehicle overlap, and accordingly, a dangerous event model is not set. Further, when the position of a lane is on the “SAME LANE” and the front and rear relationship on a road is the “REAR”, the other vehicle continuing to travel in the same lane causes the own vehicle 2 to interfere with the travel of the other vehicle, and accordingly, a dangerous event model corresponding to following on the same lane is not set. Furthermore, when the position of a lane is on the “ADJACENT LANE” and the front and rear relationship on a road is the “SIDE” or the “REAR”, the own vehicle 2 or a blocking object interferes with the travel of the other vehicle that changes lanes, and accordingly, a dangerous event model corresponding to the lane change is not set.

As described above, the blind spot region dangerous event determining unit 13 judges assumed behavior of a latent obstacle that possibly exists in each blind spot region based on the lane information of each blind spot region that the blind spot region specifying unit 12 has specified and the positional relationship of each blind spot region on a road with respect to the own vehicle 2, specifies a dangerous event model in response to the judgment result, and stores dangerous event information in the blind spot region dangerous event data group 35. Since this determines a context of a travel environment in each blind spot region and allows for appropriately estimating behavior of a moving body hidden in the blind spot region based on the context, in processes in a latter part, a latent risk brought by the blind spot region can be appropriately evaluated.

Next, using a specific traveling scene example, the processes of the blind spot region dangerous event determining unit 13, the potential obstacle generating unit 14, the potential risk map generating unit 15, and the travel control planning unit 16 in FIG. 1 and FIG. 3 will be described.

(First Operation Example)

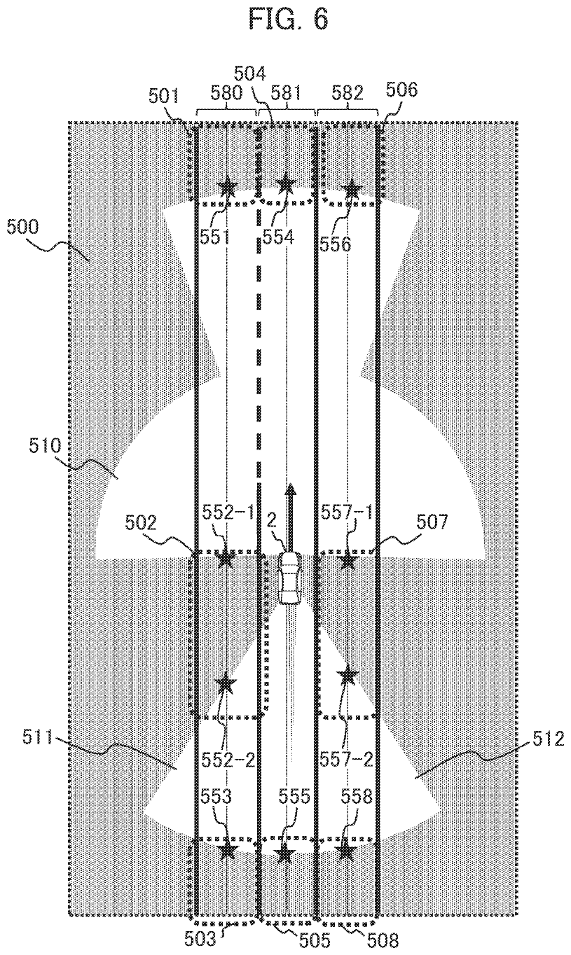

FIG. 6 illustrates a traveling scene corresponding to a first operation example of the vehicle system 1. The traveling scene illustrated in FIG. 6 illustrates a scene in which the own vehicle 2 is traveling on a lane 581 on a road having two lanes (lanes 580 and 581) in the same direction as a running direction of the own vehicle 2 and one lane (lane 582) in the opposite direction. For this traveling scene, the sensor recognition data group 31 for detection ranges 510, 511, and 512 similar to FIG. 2A is obtained by the external field sensor group 4, and a hatched region 500 that is not included in these detection ranges 510 to 512 is specified as a blind spot region by the blind spot region specifying unit 12. Note that the shapes and attributes of the lanes 580 to 582 can be specified from the travel environment data group 33.

When the process of the blind spot region specifying unit 12 is completed, the blind spot region dangerous event determining unit 13 performs the process according to the above-described flowchart illustrated in FIG. 4. In the following, a dangerous event model in the first operation example will be described as being determined in the process of FIG. 4 based on the dangerous event model decision table of FIG. 5.

The blind spot region dangerous event determining unit 13 first obtains the blind spot region data group 34 and the travel environment data group 33 corresponding the traveling scene as illustrated in FIG. 6 in the step S301 of FIG. 4. In the subsequent step S302 of FIG. 4, the process of specifying a travel environment context of a blind spot region for determining a dangerous event model is performed. Here, when the decision table of FIG. 5 is used, the positional relationship between lanes corresponds to the travel environment context of the blind spot region. Therefore, in the step S302, with reference to the lane information around the own vehicle 2 from the travel environment data group 33, regions in which the blind spot region 500 intersects with respective lane regions are extracted as blind spot regions 501 to 508. Then, to each of the extracted blind spot regions 501 to 508, the information of the positional relationship of the corresponding lane is linked. Specifically, for example, by scanning the shapes of lane center lines included in the lane information on the blind spot region data group 34 to search boundaries between the blind spot regions 501 to 508 and the detection ranges 510 to 512 as non-blind spot regions, specification of the travel environment contexts for the blind spot regions 501 to 508 is realized. Star marks 551 to 558 in FIG. 6 show boundary points between the blind spot regions 501 to 508 and the non-blind spot regions on the respective lane center lines.

Subsequently, in the step S303 of FIG. 4, the blind spot region dangerous event determining unit 13 determines the dangerous event models in the respective blind spot regions. Here, with reference to the dangerous event model decision table of FIG. 5, the respective dangerous event models corresponding to the travel environment contexts of the blind spot regions 501 to 508 are judged as below.

The blind spot regions 501 and 504 are in the running direction of the lanes with respect to the own vehicle 2 being the “SAME DIRECTION” and in the front and rear relationship on a road being the “FRONT”. Therefore, from the table of FIG. 5, the dangerous event models of the “STOP” and the “LANE CHANGE AT LOW VEHICLE SPEED” are determined to be applicable. On the other hand, the blind spot region 502 is in running direction and the positional relationship of the lane with respect to the own vehicle 2 being the “SAME DIRECTION” and the “ADJACENT LANE” respectively, and in the front and rear relationship on a road being the “SIDE”. Note that, here, it is assumed that the blind spot region 502 does not apply to a criterion of the “REAR”. Therefore, from the table of FIG. 5, the dangerous event model of a “LANE TRAVEL AT SIMILAR VEHICLE SPEED” is determined to be applicable.

The blind spot region 503 is in the running direction and the positional relationship of the lane with respect to the own vehicle 2 being the “SAME DIRECTION” and the “ADJACENT LANE” respectively, and in the front and rear relationship on a road being the “REAR”. Therefore, from the table of FIG. 5, the dangerous event model of the “LANE TRAVEL AT MAXIMUM VEHICLE SPEED” is determined to be applicable. Further, the blind spot region 505 is in the running direction and the positional relationship of the lane with respect to the own vehicle 2 being the “SAME DIRECTION” and the “SAME LANE” respectively, and in the front and rear relationship on a road being the “REAR”. Therefore, from the table of FIG. 5, the dangerous event model of a “LANE CHANGE AT MAXIMUM VEHICLE SPEED” is determined to be applicable.

The blind spot region 506 is in the running direction of the lane with respect to the own vehicle 2 being the “OPPOSITE DIRECTION” and in the front and rear relationship on a road being the “FRONT”. Therefore, from the table of FIG. 5, the dangerous event model of the “LANE TRAVEL AT MAXIMUM VEHICLE SPEED” is determined to be applicable. On the other hand, the blind spot regions 507 and 508 are in the running direction of the lane with respect to the own vehicle 2 being the “OPPOSITE DIRECTION” and in the front and rear relationship on a road being the “SIDE” and the “FRONT” respectively. Therefore, from the table of FIG. 5, it is determined that applicable dangerous event models do not exist.

Subsequently, in the step S304 of FIG. 4, the blind spot region dangerous event determining unit 13 determines the likelihood of occurrence of each dangerous event model. Here, the attributes of each lane are specified with reference to the travel environment data group 33, and the likelihood of occurrence of each dangerous event model is judged as follows.

In FIG. 6, a boundary line between the lane 580 and the lane 581 is expressed each by a solid line from the rear to the side of the own vehicle 2 and by a dashed line from the side to the front of the own vehicle 2. The solid line and the dashed line indicate that the lane change is not allowed and that the lane change is allowed, respectively. Therefore, it can be judged that the lane change from the blind spot region 505 on the lane 581 to the lane 580 is not permitted by regulations. Accordingly, the likelihood that the “LANE CHANGE AT MAXIMUM VEHICLE SPEED” determined as the dangerous event model of the blind spot region 505 in the step S303 occurs can be judged to be low.

Note that, the dangerous event models of the “LANE CHANGE AT LOW VEHICLE SPEED” of the blind spot region 501 and the blind spot region 504 overlap the dangerous event models of the “STOP” of the blind spot region 504 and the blind spot region 501 respectively in the positional relationship, and the risk of the “STOP” is higher. Therefore, the likelihood of occurrence of these dangerous event models may be judged to be low so as to be removed from the targets of the subsequent processes.

Finally, in the step S305 of FIG. 4, the blind spot region dangerous event determining unit 13 generates dangerous event information corresponding to each dangerous event model. Then, in the step S306, the dangerous event information is recorded in the blind spot region dangerous event data group 35 in the storage unit 30. Here, assuming that the dangerous event models judged to have a low likelihood of occurrence in the step S304 are removed from the generation targets of the dangerous event information, the combinations of the dangerous event model in which the dangerous event information is generated in the step S305 and the blind spot region are five sets of (“STOP”, blind spot region 501), (“LANE TRAVEL AT SIMILAR VEHICLE SPEED”, blind spot region 502), (“LANE TRAVEL AT MAXIMUM VEHICLE SPEED”, blind spot region 503), (“STOP”, blind spot region 504) and (“LANE TRAVEL AT MAXIMUM VEHICLE SPEED”, blind spot region 506). In the first operation example, for the traveling scene of FIG. 6, the dangerous event information related to these combinations is generated and recorded in the blind spot region dangerous event data group 35.

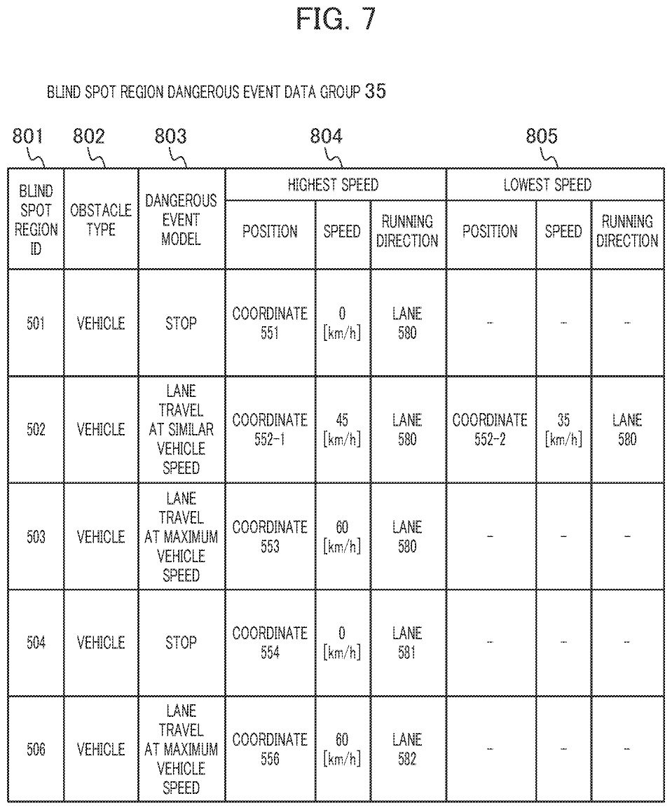

FIG. 7 illustrates an example of the blind spot region dangerous event data group 35 generated and recorded in the traveling scene of the first operation example. The blind spot region dangerous event data group 35 of FIG. 7 is configured including, for example, a blind spot region ID 801 as an identifier of a blind spot region, an obstacle type 802, a dangerous event model 803, a parameter at the highest speed 804, and a parameter at the lowest speed 805. Note that the parameter at the highest speed 804 and the parameter at the lowest speed 805 are each composed of each information of the position, speed, and running direction. Further, although the dangerous event model 803 representatively expresses a location and behavior of the most dangerous potential obstacle to the own vehicle 2, in practice, the location and the behavior of the obstacle can take various ranges. The parameter at the highest speed 804 and the parameter at the lowest speed 805 are used when these ranges need to be explicitly indicated.

From FIG. 7, it can be seen that, for example, the potential obstacle in the blind spot region 502 can range between a coordinate 552-1 and a coordinate 552-2. At this time, the potential obstacle in the blind spot region 502 can reach the farthest as a travel position after a predetermined time when the potential obstacle travels at the highest speed obtainable from the frontmost coordinate 552-1. This will be referred to as an upper limit. On the other hand, the potential obstacle remains the closest as a travel position after the same predetermined time when the potential obstacle travels at the lowest speed obtainable from the rearmost coordinate 552-2. This will be referred to as a lower limit. The range sandwiched between these upper limit and the lower limit travel positions is a possible existence range of the potential obstacle in the blind spot region 502. Note that FIG. 7 illustrates data examples of the respective blind spot regions when the speed of the own vehicle 2 is 40 km/h and the similar vehicle speed to the own vehicle 2 is set to ±5 km/h. Accordingly, in the data of the blind spot region 502, the speed with the parameter at the highest speed 804 is set to 45 km/h, and the speed at the parameter at the lowest speed 805 is set to 35 km/h. Thus, when the possible existence range of the potential obstacle according to the dangerous event model needs to be explicitly indicated, the parameter at the lowest speed is set.

On the other hand, for the blind spot regions 501, 503, 504, and 506 other than the blind spot region 502, the range cannot be specified with the upper limit and the lower limit similarly to the blind spot region 502 because the boundary exists only on one side with respect to the lane (the upper limit or the lower limit does not exist). In such a case, the boundary information on the one side is set as the parameter at the highest speed 804, and nothing is set as the parameter at the lowest speed 805. At this time, for the position of the parameter at the highest speed 804, coordinates (Star marks 551, 553, 554, and 556 in FIG. 6) of the boundary points of the respective blind spot regions are each set, and for the speed, values corresponding to the dangerous event models are each set. For example, 0 km/h is set for the blind spot regions 501 and 504 having the dangerous event model of the “STOP”, and a legally permitted speed of the corresponding lane +α is set for the blind spot regions 503 and 506 having the dangerous event model of the “LANE TRAVEL AT MAXIMUM VEHICLE SPEED”. In the example of FIG. 7, assuming that the legally permitted speed is 50 km/h and α=10 km/h, 60 km/h has been set. Note that the legally permitted speed in the blind spot region 503 and 506 can be decided based on the travel environment data group 33. At this time, the traffic condition of the blind spot regions 503 and 506 is judged based on the traffic information included in the travel environment data group 33 and the highest speed in response to the judgment result may be set.

Further, for the running directions of the respective blind spot regions, the running directions of the corresponding lanes are each set. For example, the running direction of the lane 580 for the blind spot regions 501, 502, and 503, the running direction of the lane 581 for the blind spot region 504, and the running direction of the lane 582 for the blind spot region 504, are each specified.

With the above, the process of the blind spot region dangerous event determining unit 13 is completed, and the blind spot region dangerous event data group 35 as illustrated in FIG. 7 is generated. Subsequently, the process of the potential obstacle generating unit 14 is started.

The potential obstacle generating unit 14 generates a potential obstacle using the blind spot region dangerous event data group 35 generated by the process of the blind spot region dangerous event determining unit 13 and performs the process of creating the potential obstacle data group 36. Basically, the information set in the blind spot region dangerous event data group 35 is expressed as virtual obstacle information in a data format, such as the obstacle information of the sensor recognition data group 31.

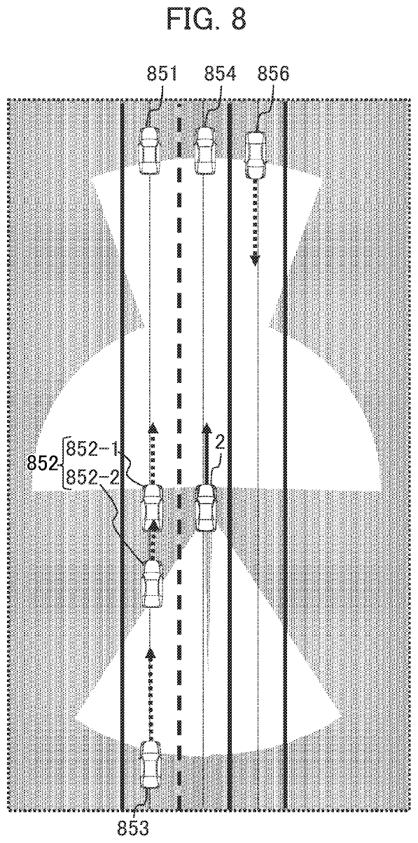

FIG. 8 illustrates an example of the potential obstacle data group 36 generated and recorded in the traveling scene of the first operation example. FIG. 8 is a view in which potential obstacles 851, 852, 853, 854, and 856 generated in accordance with the blind spot region dangerous event data group 35 of FIG. 7 and recorded in the potential obstacle data group 36 are superimposed and illustrated on the traveling scene in FIG. 6. In FIG. 8, the potential obstacles 851, 852, 853, 854, and 856 corresponding respectively to the blind spot regions 501, 502, 503, 504, and 506 of FIG. 6 are illustrated. Note that, for the blind spot regions 505, 507, and 508, since the blind spot regions 505, 507, and 508 are not included in the blind spot region dangerous event data group 35 of FIG. 7, the potential obstacles are not generated. Further, as the potential obstacle 852 in the blind spot region 502, two potential obstacles are expressed. One is a potential obstacle 852-1 having a parameter at the highest speed and the other is a potential obstacle 852-2 having a parameter at the lowest speed.

When the process of the potential obstacle generating unit 14 is completed, the process of the potential risk map generating unit is started. The following describes the process of the potential risk map generating unit 15 using FIG. 9 and FIG. 10.

The potential risk map generating unit 15 performs the process of calculating a potential risk brought by each potential obstacle at each position around the own vehicle 2 using the potential obstacle data group 36 generated by the process of the potential obstacle generating unit 14 and creating the potential risk map data group 37.

FIG. 9 illustrates a relationship estimated arrival times between potential obstacles and the own vehicle 2 at each position on the lanes in the traveling scene of the first operation example. FIG. 9A is a view illustrating the positional relationship between the own vehicle 2 and the potential obstacles on the respective lanes illustrated in FIG. 8 sideways. FIG. 9B to FIG. 9D are views illustrating the positions of the respective potential obstacles and the own vehicle 2 for each elapsed time on each of the lanes 580 to 582. In FIG. 9B to FIG. 9D, the horizontal axis indicates the position on the lane, and the vertical axis indicates the elapsed time from a current time. Further, a range where each potential obstacle may exist is illustrated by hatching, and a temporal variation of an assumed position of the own vehicle 2 is illustrated by a black solid line.

A potential risk map is a map indicating a risk in which the vehicle 2 collides with a latent obstacle hidden in a blind spot region at the periphery of the vehicle 2. Therefore, a target range for which the potential risk map is generated is preferably a range in which the vehicle 2 can reach. A black frame 880 in FIG. 9A shows a range in which the vehicle 2 can reach based on dynamic characteristics. In this operation example, the potential risk map related to the region in the black frame 880 is generated.

In FIG. 9B, the temporal variations of the assumed positions of the potential obstacles 851, 852-1, 852-2, and 853 on the lane 580 are indicated by dashed lines 861, 862-1, 862-2, and 863, respectively. The potential obstacles 852-1 and 852-2 respectively indicate the upper limit and the lower limit of a possible existence range of the potential obstacle 852 in the blind spot region 502 as described above, and a region (hatched region 872) enclosed by the two dashed lines 862-1 and 862-2 corresponding to these potential obstacles corresponds to the possible existence range of the potential obstacle 852. On the other hand, since the potential obstacle 851 has a speed of zero and an upper limit does not exist, the right side (hatched region 871) of the dashed line 861 becomes a possible existence range of the potential obstacle 851. Note that, considering a margin in FIG. 9B, the hatched region 871 is also set on the left side of the dashed line 861. Further, since, also for the potential obstacle 853, a lower limit side does not exist against the dashed line 863 as an upper limit, the left upper side (hatched region 873) of the dashed line 863 becomes a possible existence range of the potential obstacle 853.

In FIG. 9C, the temporal variation of the assumed position of the potential obstacles 854 on the lane 581 is indicated by a dashed line 864. Since the potential obstacle 854 has a speed of zero and an upper limit does not exist in its possible existence range, the right side (hatched region 874) of the dashed line 864 becomes the possible existence range of the potential obstacle 854. Note that, similarly to FIG. 9B, considering a margin in FIG. 9C, the hatched region 874 is also set on the left side of the dashed line 864.

In FIG. 9D, the temporal variation of the assumed position of the potential obstacles 856 on the lane 582 is indicated by a dashed line 866. Since the potential obstacle 856 indicates a case where an oncoming vehicle travels at a maximum vehicle speed and an upper limit does not exist in its possible existence range against the dashed line 866 as a lower limit, the right upper side (hatched region 876) of the dashed line 866 becomes the possible existence range of the potential obstacle 856.

A potential risk at each position (corresponding to each grid point of a grid map) on the potential risk map is obtained from a degree of overlapping of a time range in which a potential obstacle possibly exists at the position and a time range in which the own vehicle 2 is assumed to exist at this position. For example, at a position 841 illustrated on the horizontal axis in FIG. 9B, the potential obstacle possibly exists in two time ranges. One is a part 891-1 corresponding to the position 841 in the hatched region 873 showing the possible existence range of the potential obstacle 853, and the other is a part 891-2 corresponding to the position 841 in the hatched region 872 showing the possible existence range of the potential obstacle 852. In contrast, a solid line 881 showing the temporal variation of the assumed position of the own vehicle 2 is contained in the part 891-2 showing an existence time range of the potential obstacle 852. That is, since, at the position 841, the time range in which the own vehicle 2 is assumed to exist at that position overlaps the potential obstacle 852, it is shown that there is a likelihood (potential risk) that the own vehicle 2 collides with the potential obstacle 852.

The potential risk may be expressed by binary values of with danger and without danger or may be expressed by a level of predetermined number of stages (for example, high risk, middle risk, and low risk). Further, the potential risk may be expressed by a numerical value in a predetermined range (for example, 0 to 100). When the potential risk is expressed by the numerical value, it is preferable that, in the process of the blind spot region dangerous event determining unit 13 in FIG. 4, by a product of a weight constant w based on the likelihood of occurrence calculated in the step S304 and an overlapping degree p representing an extent of overlapping of the existence time ranges of the potential obstacle and the own vehicle 2, the value of the potential risk is calculated. For example, with respect to a distance d between the existence time range of the potential obstacle and the existence time range of the own vehicle 2, the above-described overlapping degree p can be calculated based on a function (for example, Gaussian function) with which the maximum value is taken when the d is zero and the value decreases as the d increases.

FIG. 10 illustrates an example of the potential risk map data group 37 generated and recorded in the traveling scene of the first operation example. FIG. 10 is a view illustrating a result of calculating the potential risks brought by the respective potential obstacles based on the relationship of the estimated arrival times between the potential obstacles and the own vehicle 2 illustrated in FIG. 9. Note that, in FIG. 10, the potential risk is shown by the binary representation for simplicity.

In FIG. 10, regions 951, 952, 954, and 956 that are hatched inside the region 880 as an expression target of the potential risk map each show a region with a potential risk (potential risk region). The potential risk region 951, the potential risk region 952, the potential risk region 954, and the potential risk region 956 indicate a potential risk by the potential obstacle 851 (to be precise, including the potential obstacle 852), a potential risk by the potential obstacle 852, a potential risk by the potential obstacle 854, and a potential risk by the potential obstacle 856, respectively. Note that, although, in FIG. 10, in order to facilitate understanding, the potential obstacles 851, 852-1, 852-2, 854, and 856 and the positions of the respective lanes on the road are illustrated on the potential risk map, these do not necessarily need to be expressed on the potential risk map.

When the process of the potential risk map generating unit 15 is completed, the process of the travel control planning unit 16 is started. The travel control planning unit 16 executes the process of creating the travel control data group 38 by procedures of (1) specifying a physical route (travel route) on which the own vehicle travels, (2) making a speed plan on this travel route and generating a travel track with speed information added to the travel route, and (3) calculating a control command value of the actuator group 7 for following this travel track.

In specifying the travel route in the procedure (1), for example, a plurality of candidates of travel routes that can be taken are generated in advance based on the information of the own vehicle speed, the lane shape, and the like and are evaluated including the speed plan in the procedure (2), and the comprehensively most preferable travel track is finally selected. The potential risk map data group 37 is used for this evaluation. Originally, in the evaluation of the travel track, not only the potential risk, but also various environmental elements, such as the obstacles detected by the external field sensor group 4 and traffic rules, are comprehensively considered. However, here, the description will be made narrowing down to the potential risk for simplicity.

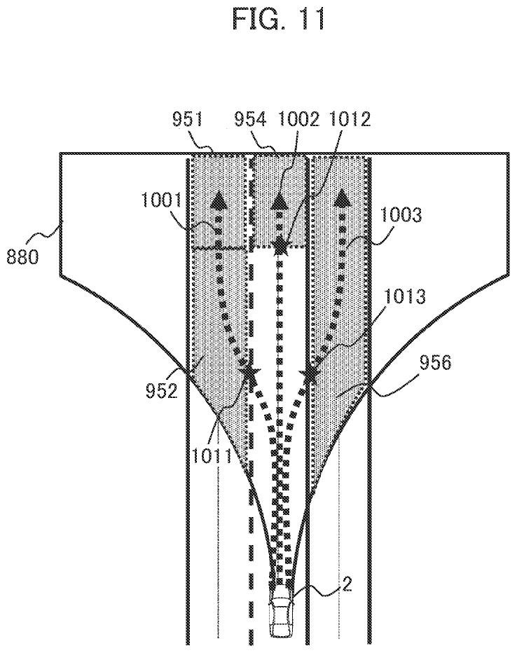

FIG. 11 illustrates a relationship between the travel route candidates that the own vehicle 2 can take and the potential risks in the traveling scene of the first operation example. FIG. 11 is a view in which travel route candidates 1001 to 1003 that the own vehicle 2 can take are superimposed and illustrated on the potential risk map data group 37 generated by the potential risk map generating unit 15. In FIG. 11, the regions 951, 952, 954, and 956 are identical to the regions illustrated in FIG. 10 and each shows the region having a high potential risk. The travel route candidates 1001 to 1003 intersect with the regions 952, 954, and 956 at positions 1011 to 1013, respectively.

The potential risk is different from a collision risk against the obstacle actually detected by the external field sensor group 4 and indicates a collision risk against a potential obstacle that does not necessarily exist. In the travel control of the own vehicle 2, against the obstacle that surely exists, it is preferable to generate a track that the own vehicle 2 surely avoids without impairing a ride comfort of an occupant. However, against the potential obstacle, when the potential obstacle actually exists by any chance, it is only necessary to secure minimal safety even if the ride comfort is sacrificed to some extent. This is because the potential obstacle is less likely to actually exist, and performing a control equal to a control for the ordinary obstacle causes the travel to be excessively conscious of a risk and the ride comfort and traveling stability to deteriorate. Therefore, in this embodiment, in the travel control planning unit 16, for a region having a high potential risk on the potential risk map that the potential risk map data group 37 indicates, a policy of generating a travel track on which the own vehicle 2 can secure the minimal safety is employed.

In order to secure the minimal safety against the potential risk, in the travel control planning unit 16, the travel route candidates 1001 to 1003 are generated, for example, at the speed at which the own vehicle 2 can stop before entering the regions 952, 954, and 956 having a high potential risk. The regions 952, 954, and 956 indicate the regions that may collide with a potential obstacle as described above. Therefore, in the worst case, once the own vehicle 2 enters the locations, there is a riskiness that the own vehicle 2 collides with a potential obstacle when the potential obstacle actually exists. However, as long as the own vehicle 2 can be decelerated and stopped just before the corresponding position at a critical moment, such as when the external field sensor group 4 detects a colliding risk, a collision can be avoided beforehand even when the own vehicle 2 is made to travel following the travel route candidates 1001 to 1003.

When a deceleration that is acceptable in the own vehicle 2 is set to a and a current speed of the own vehicle 2 is set to v, a distance until the own vehicle 2 stops can be obtained by v²/2α. In a case where any of the travel route candidates 1001 to 1003 is set to a travel route of the own vehicle 2, when a distance from a current position of the own vehicle 2 to positions where this travel route intersects with the respective regions 952, 954, and 956 having a high potential risk, that is, to the positions 1011 to 1013 in FIG. 11 is set to L, the travel control device 3 needs to control the speed of the own vehicle 2 so as to satisfy at least L>v²/2α. However, since this causes a sudden deceleration to be applied at the instant when this condition is not satisfied, in practice, it is preferable to gradually decelerate before this condition is not satisfied. For example, a method of adjusting the speed of the own vehicle 2 based on a TTB (Time To Braking) introduced as an index is exemplified. The TTB is a time until the own vehicle 2 reaches a point where this condition is not satisfied. Note that, the value of the TTB can be calculated by (L−v²/2α)/v. In order to avoid the sudden deceleration, for example, the deceleration (<α) may be gradually applied when the TTB becomes equal to or less than a predetermined value, or the speed may be controlled so that the TTB becomes equal to or more than a predetermined value.

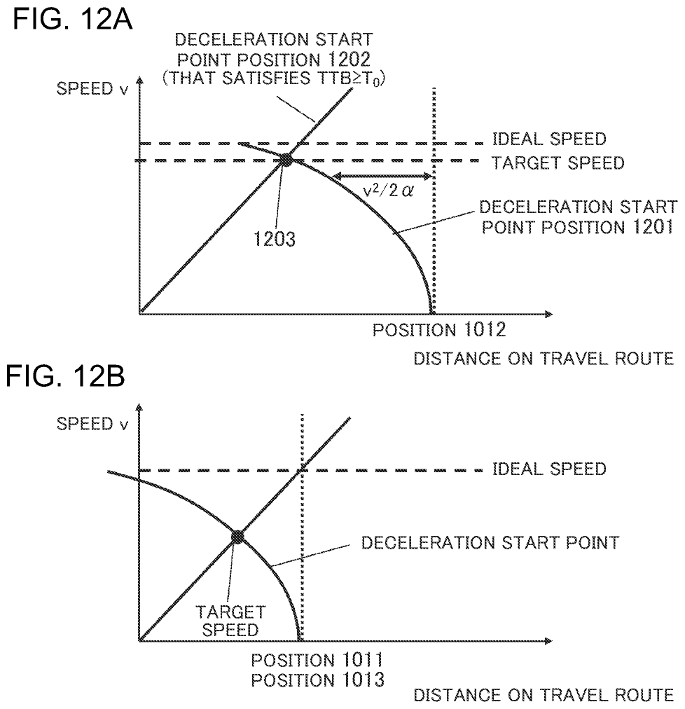

FIG. 12 illustrates an example of a calculation method of the travel route candidates and target speeds in the traveling scene of the first operation example. FIG. 12 are views indicating relationships between a position of a deceleration start point for the own vehicle 2 to stop just before entering a region having a high potential risk and a position of a deceleration start point when the speed of the own vehicle 2 is controlled so that the TTB becomes equal to or more than a predetermined value T₀ on the travel route candidates 1001 to 1003 in FIG. 11. FIG. 12A indicates the above-described relationship related to the travel route candidate 1002, and FIG. 12B indicates the above-described relationship related to the travel route candidates 1001 and 1003. In these views, the horizontal axis indicates the distance on the travel routes, and the vertical axis indicates the speed of the own vehicle 2.

As illustrated in FIG. 11, the travel route candidate 1002 intersects with the region 954 having a high potential risk at the position 1012. As illustrated by a deceleration start point position 1201 in FIG. 12A, the deceleration start point for the own vehicle 2 to stop just before the position 1012 when the own vehicle 2 travels along the travel route candidate 1002 is a position just before the position 1012 by v²/2α. In contrast, in order to satisfy TTB To, as illustrated by a deceleration start point position 1202 in FIG. 12A, the deceleration start point must be ahead of the current position by Tov. An intersection point 1203 of both of these becomes the target speed that satisfies the condition.

On the other hand, as illustrated in FIG. 11, on the travel route candidates 1001 and 1003, the positions 1011 and 1013 that are intersection points with the regions 952 and 956 having a high potential risk exist on a near-side with respect to the above-described position 1012. Therefore, as illustrated in FIG. 12B, the target speed that satisfies the condition becomes significantly lower than the case of the travel route candidate 1002, leading to an undesired result. Therefore, the travel control planning unit 16 plans a travel track for causing the own vehicle 2 to travel at the target speed in FIG. 12A along the travel route candidate 1002, calculates a control command value for following the travel track, and generate the travel control data group 38. The control command value indicated by the travel control data group 38 generated in this way is output to the actuator group 7 by the process of the information output unit 17.

Note that the target speed of FIG. 12A falling below an ideal speed (for example, legally permitted speed) means that the detection range by the external field sensor group 4 does not satisfy a requirement for causing the own vehicle 2 to travel safely at the ideal speed. This is caused by an original performance limit of the external field sensor group 4, and when this is considered by replacing with a manual operation, this corresponds to traveling by decelerating by a human for safety at the time of poor visibility in front due to bad weather, sharp curves, and the like. That is, since the blind spot region of the external field sensor group 4 comes close to the own vehicle 2 in bad weather and at the sharp curves, and the like, the intersection point with the region having a high potential risk on the travel route also becomes close. Therefore, the deceleration start point position 1201 in FIG. 12A shifts to the left, whereby the intersection point 1203 with the deceleration start point position 1202 shifts to the left, and the target speed decreases.

As described above, in the vehicle system 1 of this embodiment, by using the potential risk map expressing the risk of the potential obstacle hidden in the blind spot region, the safe travel control based on the blind spot and the detection state of the external field sensor group 4 can be easily realized.

(Second Operation Example)

Next, using different traveling scene examples from the above-described traveling scene, the specific processes of the blind spot region dangerous event determining unit 13, the potential obstacle generating unit 14, the potential risk map generating unit 15, and the travel control planning unit 16 in FIG. 1 and FIG. 3 will be described.

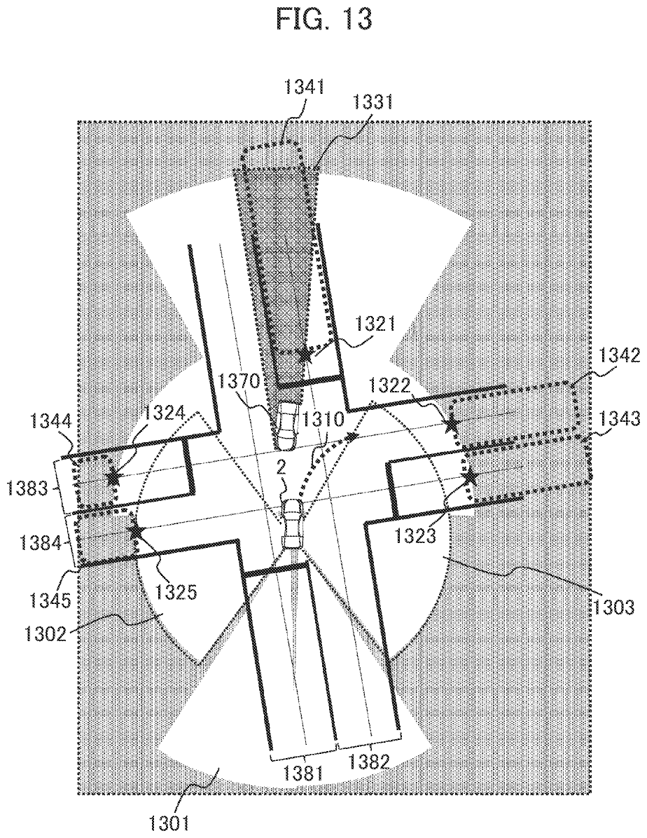

FIG. 13 illustrates a first traveling scene corresponding to a second operation example of the vehicle system 1. FIG. 13 illustrates a traveling scene in which a road in a longitudinal direction composed of lanes 1381 and 1382 opposing to each other and a road in a lateral direction composed of lanes 1383 and 1384 opposing to each other are intersected at a crossroad intersection with signals and the own vehicle 2 turns right from the lane 1381 toward the lane 1383 at this intersection. For this traveling scene, the sensor recognition data group 31 for a detection range 1301 is obtained by the external field sensor group 4, and a hatched region that is not included in this detection range 1301 is specified as a blind spot region by the blind spot region specifying unit 12. In this blind spot region, a blind spot region 1331 formed by an oncoming vehicle 1370 becoming a blocking object is included. The oncoming vehicle 1370 is standing by near the center of the intersection in an attempt to turn right on the oncoming lane 1382 of the own vehicle 2. Note that in the second operation example, compared to the first operation example, a sensor that can detect the sides of the own vehicle 2 is added to the external field sensor group 4, and detection ranges 1302 and 1303 by this sensor are included in the detection range 1301 of the external field sensor group 4.

In the traveling scene of FIG. 13, the shapes and attributes of the lanes 1381 to 1384 can be specified from the travel environment data group 33. Further, for the signals of the intersection, the signal on the road in the longitudinal direction is assumed to be green, and the signal on the road in the lateral direction is assumed to be in a red state. Note that the states of the signals can be also specified from the travel environment data group 33.

When the process of the blind spot region specifying unit 12 is completed, the blind spot region dangerous event determining unit 13 performs the process according to the above-described flowchart illustrated in FIG. 4.

The blind spot region dangerous event determining unit 13 first obtains the blind spot region data group 34 and the travel environment data group 33 corresponding the traveling scene as illustrated in FIG. 13 in the step S301 of FIG. 4. In the subsequent step S302 of FIG. 4, similarly to the first operation example, with reference to the lane information around the vehicle from the travel environment data group 33, blind spot regions 1341 to 1345 for the respective lanes are extracted, and in addition, boundary points 1321 to 1325 between the blind spot regions 1341 to 1345 and the detection range 1301 as a non-blind spot region are specified.

Subsequently, in the step S303 of FIG. 4, the blind spot region dangerous event determining unit 13 determines the dangerous event models in the respective blind spot regions. Here, similarly to the first operation example, by referring to the dangerous event model decision table of FIG. 5, the respective dangerous event models corresponding to the blind spot regions 1341 to 1345 are judged as below.

Since the own vehicle 2 turns right from the lane 1381 toward the lane 1383 at the intersection, the blind spot region 1341 on the lane 1382 as the oncoming lane of the lane 1381 and the blind spot region 1343 on the lane 1384 as the oncoming lane of the lane 1383 are judged to be in the running direction of the lanes with respect to the own vehicle 2 being the “OPPOSITE DIRECTION” and in the front and rear relationship on a road being the “FRONT”. Therefore, from the table of FIG. 5, the dangerous event model of the “LANE TRAVEL AT MAXIMUM VEHICLE SPEED” is determined to be applicable. Further, the blind spot region 1342 on the lane 1383 is in the running direction of the lane with respect to the own vehicle 2 being the “SAME DIRECTION” and in the front and rear relationship on a road being the “FRONT”. Therefore, from the table of FIG. 5, the dangerous event model of the “STOP” is determined to be applicable. Note that, here, since only one lane exists in the same direction, the dangerous event model of the “LANE CHANGE AT LOW VEHICLE SPEED” is judged to be not applicable.

In the traveling scene of FIG. 13, the state where the own vehicle 2 has already started turning right at the intersection as described above and cannot travel in a straight line or turn left is assumed. Therefore, the blind spot regions 1344 and 1345 are treated as being in the front and rear relationship on a road being the “REAR”. Further, for the running direction of the lane with respect to the own vehicle 2, the blind spot region 1344 is in the “SAME DIRECTION (ADJACENT LANE)” and the blind spot region 1345 is in the “OPPOSITE DIRECTION”. Therefore, from the table of FIG. 5, the dangerous event models of the “LANE TRAVEL AT MAXIMUM VEHICLE SPEED” and a “NOT APPLICABLE (N/A)” are determined to be applicable for the blind spot region 1344 and the blind spot region 1345, respectively. Note that since the own vehicle 2 can head for either going straight or turning right or left in the case before the own vehicle 2 enters the intersection, the blind spot regions 1344 and 1345 are treated as being in the front and rear relationship on a road being the “FRONT”.

Subsequently, in the step S304 of FIG. 4, the blind spot region dangerous event determining unit 13 determines the likelihood of occurrence of each dangerous event model. In the traveling scene of FIG. 13, since the signal for the road across the view in the lateral direction is in the red state, the likelihood of a vehicle rushing out from the blind spot regions 1343 and 1344 can be judged to be low. Accordingly, the likelihood of the respective dangerous event models determined for the blind spot regions 1343 and 1344 in the step S303 can be judged to be low.

Finally, in the step S305 of FIG. 4, the blind spot region dangerous event determining unit 13 generates dangerous event information corresponding to each dangerous event model. Then, in the step S306, the dangerous event information is recorded in the blind spot region dangerous event data group 35 in the storage unit 30. Here, assuming that the dangerous event models of the blind spot regions 1343 and 1344 in which the likelihoods of occurrence are judged to be low in the step S304 are removed from the generation targets of the dangerous event information, the combinations of the dangerous event model and the blind spot region in which the dangerous event information is generated in the step S305 are two sets of (“LANE TRAVEL AT MAXIMUM VEHICLE SPEED”, blind spot region 1341) and (“STOP”, blind spot region 1342). In the second operation example, for the traveling scene of FIG. 13, the dangerous event information related to these combinations is generated and recorded in the blind spot region dangerous event data group 35.

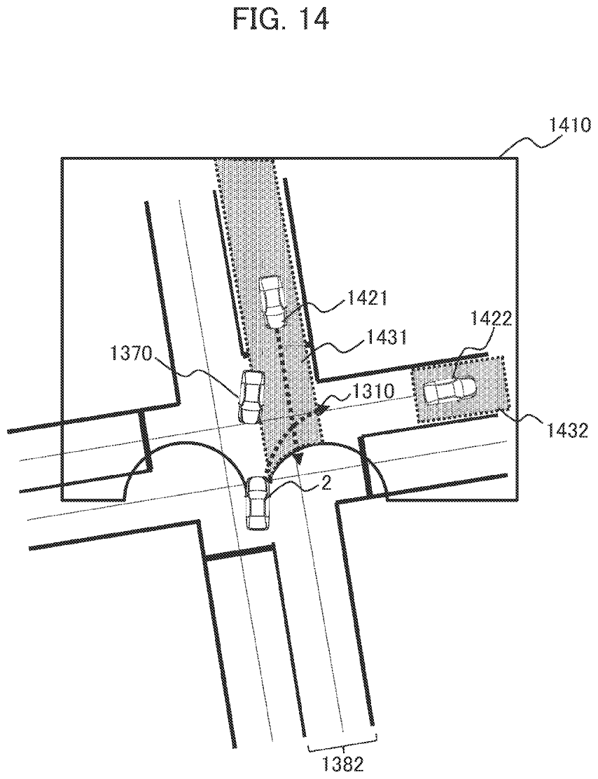

Subsequently, a result of the processes of the potential obstacle generating unit 14 and the potential risk map generating unit 15 will be described using FIG. 14 to FIG. 17. FIG. 14 illustrates an example of the potential obstacle data group 36 and the potential risk map data group 37 generated and recorded in the first traveling scene of the second operation example. FIG. 14 illustrates potential obstacles 1421 and 1422 generated by the potential obstacle generating unit 14 and recorded in the potential obstacle data group 36 in accordance with the blind spot region dangerous event data group 35 for the traveling scene of FIG. 13 and a potential risk map generated for these potential obstacles and recorded in the potential risk map data group 37. In FIG. 14, regions 1431 and 1432 that are hatched inside a region 1410 as an expression target of the potential risk map each indicate a region having a high potential risk by the potential obstacles 1421 and 1422.

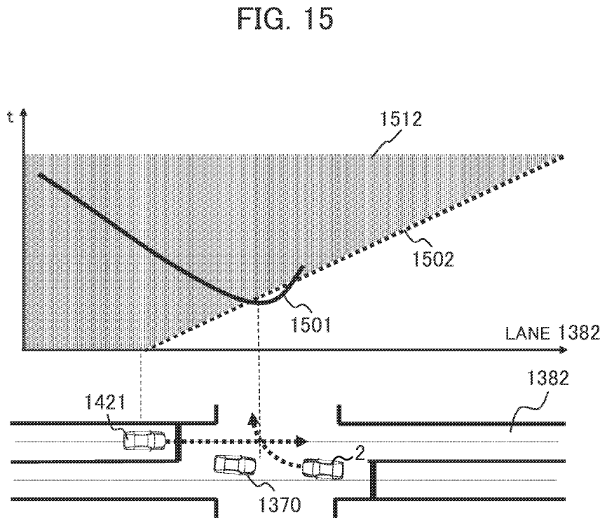

FIG. 15 illustrates a relationship of estimated arrival times between a potential obstacle and the own vehicle 2 at each position on the lane in the first traveling scene of the second operation example. In FIG. 15, for the lane 1382 in FIG. 14, the positional relationship between the own vehicle 2 and the oncoming vehicle 1370 and potential obstacle 1421 is illustrated sideways, and in addition, the positions of the potential obstacle 1421 and the own vehicle 2 for each elapsed time are illustrated. In the upper view of FIG. 15, the horizontal axis indicates the position on the lane 1382, and the vertical axis indicates the elapsed time from a current time. Further, a temporal variation of an assumed position of the own vehicle 2 is indicated by a black solid line 1501 and a temporal variation of an assumed position of the potential obstacle 1421 is indicated by a dashed line 1502. In addition, a region where the potential obstacle 1421 may exist is indicated by a hatched region 1512. Note that on the solid line 1501, the data corresponding to a part from the side to the rear of the own vehicle 2 does not exist. This is because the data of a part that cannot be reached due to a relationship of a turning radius of the own vehicle 2 is not set.

In FIG. 15, the solid line 1501 indicating the temporal variation of the assumed position of the own vehicle 2 is contained in the hatched region 1512 indicating a possible existence range of the potential obstacle 1421. This means that a potential risk by the potential obstacle 1421 is high in the hatched region 1512. Accordingly, as illustrated in FIG. 14, the region 1431 for the potential obstacle 1421 is expressed on the potential risk map.

When the potential risk map of FIG. 14 is viewed, the region 1431 having a high potential risk exists on a right turn route 1310 of the own vehicle 2. That is, it means that when the own vehicle starts moving as it is, in the case where another vehicle is hidden in a blind spot of the oncoming vehicle 1370, there is a risk of colliding with that vehicle.

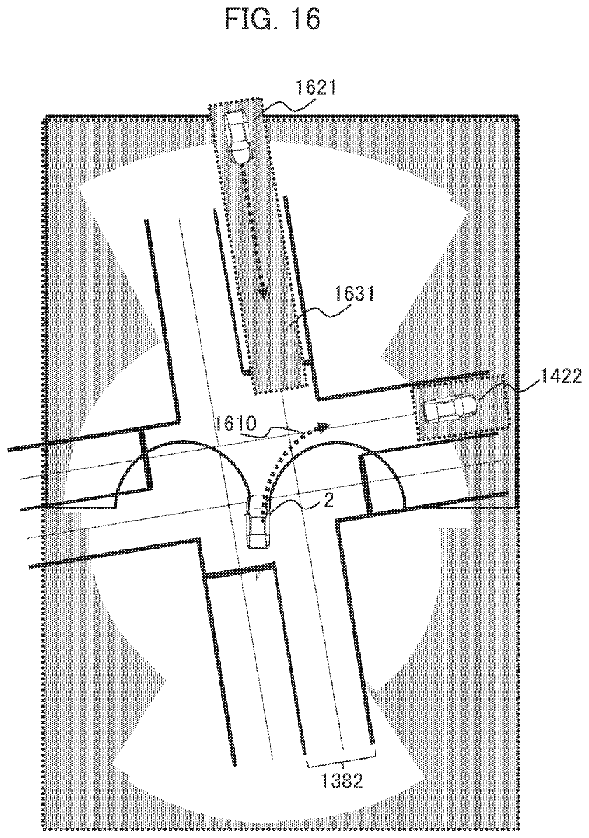

FIG. 16 illustrates a second traveling scene corresponding to the second operation example of the vehicle system 1. In FIG. 16, a traveling scene in which the oncoming vehicle 1370 waiting for a right turn ahead of the own vehicle 2 in FIG. 13 has disappeared and potential obstacles and a potential risk map in that traveling scene are illustrated. In the traveling scene of FIG. 16, since the blind spot region 1331 by the oncoming vehicle 1370 that has existed in FIG. 13 disappears, the boundary point between the blind spot region of the oncoming lane 1382 and the non-blind spot region retreats to a detection limit point of the external field sensor group 4. As a result, a potential obstacle 1621 is generated by the process of the potential obstacle generating unit 14 and a region 1631 illustrated by hatching is expressed on the potential risk map as a region having a high potential risk by this potential obstacle 1621.

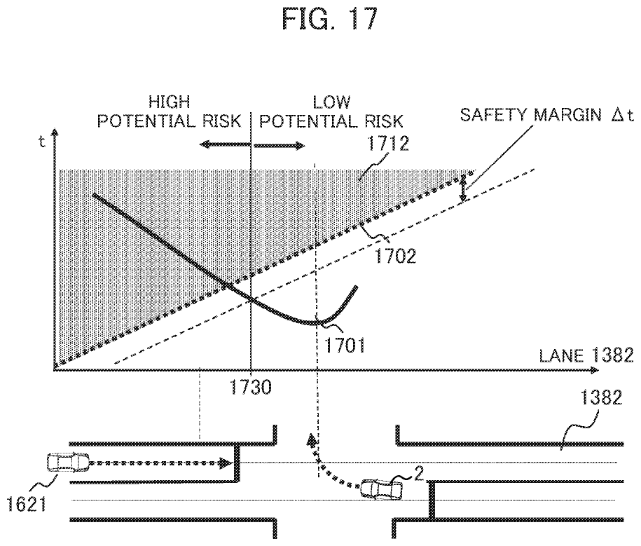

FIG. 17 illustrates a relationship of estimated arrival times between a potential obstacle and the own vehicle 2 at each position on the lane in the second traveling scene of the second operation example. In FIG. 17, for the lane 1382 in FIG. 16, the positional relationship between the own vehicle 2 and the potential obstacle 1621 is illustrated sideways, and in addition, the positions of the potential obstacle 1621 and the own vehicle 2 for each elapsed time are illustrated. Similarly to FIG. 15, in FIG. 17, the horizontal axis of the upper view indicates the position on the lane 1382, and the vertical axis indicates the elapsed time from a current time. Further, a temporal variation of an assumed position of the own vehicle 2 is indicated by a black solid line 1701 and a temporal variation of an assumed position of the potential obstacle 1621 is indicated by a dashed line 1702. In addition, a region where the potential obstacle 1621 may exist is indicated by a hatched region 1712.

In the traveling scene of FIG. 16, the blind spot region on the lane 1382 is set at a position farther apart from the intersection than the blind spot region 1331 in FIG. 13. Therefore, as illustrated in FIG. 17, the hatched region 1712 indicating a possible existence range of the potential obstacle 1621 shifts to the left side of the view compared with the hatched region 1512 in FIG. 15. As a result, the solid line 1701 indicating the temporal variation of the assumed position of the own vehicle 2 on the lane 1382 and the hatched region 1712 indicating the possible existence range of the potential obstacle 1621 do not overlap near the intersection. Here, assuming that a potential risk is low when the respective estimated arrival times of the own vehicle 2 and the potential obstacle 1621 with respect to the same position are separated by a predetermined safety margin Δt or more, the potential risk is judged to be low in a region on the right side with respect to a position 1730 in FIG. 17. The hatched region 1631 in FIG. 16 is the region expressing this on the potential risk map.

In the potential risk map of FIG. 16, a region having a high potential risk does not exist on a right turn route 1610 of the own vehicle 2. That is, it means that when the own vehicle 2 starts moving as it is, there is no risk of colliding with another vehicle that travels on the oncoming lane 1382.

As described above, in the vehicle system 1 of this embodiment, the estimated arrival times of the potential obstacle and the own vehicle 2 with respect to the same position are each calculated, and based on whether these temporally cross, the calculated potential risk is expressed on the potential risk map. In this way, by searching an intersection point of an assumed route of the own vehicle 2 and the region having a high potential risk on the potential risk map, a riskiness brought by the obstacle that potentially exists in the blind spot region can be judged. Therefore, for example, even in a right turn in a state where the oncoming lane is not appropriately seen due to the oncoming vehicle waiting for a right turn, propriety of starting to move can be safely judged.

According to one embodiment of the present invention described above, the following operational advantages are provided.

(1) The travel control device 3 as an ECU mounted on the vehicle 2 includes the blind spot region specifying unit 12 that specifies a blind spot region that is not included in a detection range of the external field sensor group 4 mounted on the vehicle 2, the information obtaining unit 11 that obtains lane information of a road around the vehicle 2 including the blind spot region that the blind spot region specifying unit 12 has specified, and the blind spot region dangerous event determining unit 13. The blind spot region dangerous event determining unit 13 judges assumed behavior of a latent obstacle that possibly exists in the blind spot region based on the lane information of the blind spot region that the information obtaining unit 11 has obtained and a positional relationship of the blind spot region on the road with respect to the vehicle 2. This allows for appropriately judging the behavior of the latent obstacle that possibly exists in the blind spot region.

(2) The travel control device 3 further includes the potential risk map generating unit 15 that generates a potential risk map that expresses a latent travel risk at a periphery of the vehicle 2 based on the assumed behavior of the latent obstacle. This allows for appropriately evaluating a risk that the latent obstacle that possibly exists in the blind spot region poses to the vehicle 2.

(3) The travel control device 3 further includes the information output unit 17 that outputs a control command value of the actuator group 7 that is information for controlling the vehicle 2 while maintaining a travel state that allows for avoiding a danger with respect to a potential risk region that is a region having a predetermined value or more of the latent travel risk expressed on the potential risk map. Here, the travel state that allows for avoiding a danger is preferably a travel state that satisfies a condition that the vehicle 2 is stoppable before reaching the potential risk region. This allows for causing the vehicle 2 to travel so as to be able to surely avoid a collision with an obstacle even in a case where the obstacle exists in the blind spot region.

(4) As described with FIG. 9, FIG. 15, and FIG. 17, the potential risk map generating unit 15 judges an estimated arrival time of the vehicle 2 at a peripheral position of the vehicle 2 based on behavior of the vehicle 2, and in addition, judges an estimated arrival time of the latent obstacle at the peripheral position of the vehicle 2 based on the assumed behavior of the latent obstacle. Then, the latent travel risk at the peripheral position of the vehicle 2 is judged based on an overlapping of the estimated arrival time of the vehicle 2 and the estimated arrival time of the latent obstacle. This allows for appropriately judging a latent travel risk at the peripheral position of the vehicle 2.

(5) As described with the dangerous event model decision table of FIG. 5, the blind spot region dangerous event determining unit 13 judges that the latent obstacle is at a stop when a running direction that the lane information of the blind spot region indicates and a running direction of the vehicle 2 match, and when the blind spot region is positioned at a front on the road with respect to the vehicle 2. Further, it is judged that the latent obstacle is traveling at the highest speed in response to a road environment of the blind spot region when the running direction that the lane information of the blind spot region indicates and the running direction of the vehicle 2 differ, and when the blind spot region is positioned at a front on the road with respect to the vehicle 2. At this time, it is possible to calculate the highest speed, for example, based on a legally permitted speed that the lane information of the blind spot region indicates and information related to a traffic condition of the blind spot region included in traffic information that the information obtaining unit 11 has obtained. Further, it is judged that the latent obstacle is traveling at a similar speed to the vehicle 2 when the running direction that the lane information of the blind spot region indicates and the running direction of the vehicle 2 match, and when the blind spot region is positioned at a side on the road with respect to the vehicle 2. This allows for appropriately judging the assumed behavior of the latent obstacle that possibly exists in the blind spot region.

Note that the embodiment described above is one example, and the present invention is not limited to this. That is, various applications are possible in the present invention, and all embodiments are included within the scope of the present invention. For example, in the above-described embodiment, although the blind spot region is expressed in a predetermined shape, the blind spot region may be expressed in the unit of cell of a grid-like map as illustrated in FIG. 2 or may be expressed by a collective body of a plurality of cells.

Further, for example, in the above-described embodiment, although the example in which each process is executed using one each of the processing unit 10 and the storage unit 30 in the travel control device 3 is described, a configuration is made by dividing the processing units 10 and the storage units 30 into a plurality of units and each process may be executed by a different processing unit or storage unit. In that case, for example, a form in which process software having a similar configuration is mounted in each storage unit and each processing unit shares the execution of this process may be applied.

Further, in the above-described embodiment, although each process of the travel control device 3 is realized by executing a predetermined operation program using a processor and a RAM, each process can be realized with a unique hardware as necessary. Further, in the above-described embodiment, although the external field sensor group 4, the vehicle sensor group 5, the actuator group 7, the HMI device group 8, and the outside communication device 9 are described as respective individual devices, realization can be made by combining any arbitrary two or more devices as necessary.

Further, in the drawings, control lines and information lines that are considered to be necessary in order to describe the embodiment are shown, and all the control lines and the information lines included for actual products in which the present invention is applied are not necessarily shown. It can be considered that almost all the configurations are actually connected to each other.

Priority is claimed on Japanese Patent Application No. 2019-169821 filed on Sep. 18, 2019, the content of which is incorporated herein by reference.

### LIST OF REFERENCE SIGNS

1 vehicle system
2 vehicle
3 travel control device
4 external field sensor group
5 vehicle sensor group
6 map information management device
7 actuator group
8 HMI device group
9 outside communication device
10 processing unit
11 information obtaining unit
12 blind spot region specifying unit
13 blind spot region dangerous event determining unit
14 potential obstacle generating unit
15 potential risk map generating unit
16 travel control planning unit
17 information output unit
30 storage unit
31 sensor recognition data group
32 vehicle information data group
33 travel environment data group
34 blind spot region data group
35 blind spot region dangerous event data group
36 potential obstacle data group
37 potential risk map data group
38 travel control data group
40 communication unit

1. An electronic control device mounted on a vehicle comprising:
a blind spot region specifying unit that specifies a blind spot region that is not included in a detection range of a sensor mounted on the vehicle;
an information obtaining unit that obtains lane information of a road around the vehicle including the blind spot region; and
a blind spot region dangerous event determining unit that judges assumed behavior of a latent obstacle that possibly exists in the blind spot region based on the lane information of the blind spot region and a positional relationship of the blind spot region on the road with respect to the vehicle.

2. The electronic control device according to claim 1, further comprising:
a potential risk map generating unit that generates a potential risk map that expresses a latent travel risk at a periphery of the vehicle based on the assumed behavior of the latent obstacle.

3. The electronic control device according to claim 2, further comprising:
an information output unit that outputs information for controlling the vehicle while maintaining a travel state that allows for avoiding a danger with respect to a potential risk region that is a region having a predetermined value or more of the latent travel risk expressed on the potential risk map.

4. The electronic control device according to claim 3,
wherein the travel state that allows for avoiding a danger is a travel state that satisfies a condition that the vehicle is stoppable before reaching the potential risk region.

5. The electronic control device according to claim 2,
wherein the potential risk map generating unit:
judges an estimated arrival time of the vehicle at a peripheral position of the vehicle based on behavior of the vehicle;
judges an estimated arrival time of the latent obstacle at the peripheral position of the vehicle based on the assumed behavior of the latent obstacle; and
judges a latent travel risk at the peripheral position of the vehicle based on an overlapping of the estimated arrival time of the vehicle and the estimated arrival time of the latent obstacle.

6. The electronic control device according to claim 1,
wherein the blind spot region dangerous event determining unit judges that the latent obstacle is at a stop when a running direction that the lane information of the blind spot region indicates and a running direction of the vehicle match, and when the blind spot region is positioned at a front on the road with respect to the vehicle.

7. The electronic control device according to claim 1,
wherein the blind spot region dangerous event determining unit judges that the latent obstacle is traveling at a highest speed in response to a road environment of the blind spot region when a running direction that the lane information of the blind spot region indicates and a running direction of the vehicle differ from each other, and when the blind spot region is positioned at a front on the road with respect to the vehicle.

8. The electronic control device according to claim 7,
wherein the blind spot region dangerous event determining unit calculates the highest speed based on a legally permitted speed that the lane information of the blind spot region indicates.

9. The electronic control device according to claim 7,
wherein the information obtaining unit obtains traffic state including information related to a traffic condition of the blind spot region, and
the blind spot region dangerous event determining unit calculates the highest speed based on the traffic information of the blind spot region that the traffic information indicates.

10. The electronic control device according to claim 1,
wherein the blind spot region dangerous event determining unit judges that the latent obstacle is traveling at a similar speed to the vehicle when a running direction that the lane information of the blind spot region indicates and a running direction of the vehicle match, and when the blind spot region is positioned at a side on the road with respect to the vehicle.
